(19) United States
(12) Patent Application Publication
(10) Pub. No.: US 2010/0235313 A1
(43) Pub. Date: Sep. 16, 2010

(54) Media information analysis and recommendation platform

(76) Inventors: Tim Rea, Suffolk (GB); Eric Sellin, Suffolk (GB); Simon Steward, London (GB)

Correspondence Address: THE NATH LAW GROUP, 112 South West Street, Alexandria, VA, 22314, US

(21) Appl. No.: 12/382,413

(22) Filed: Mar. 16, 2009

(51) Int. Cl. G06N 5/02; G06F 17/27

(52) U.S. Cl. 706/52; 706/54; 704/9

(57) ABSTRACT

A hybrid approach for personalized recommendation of subject matter description is described, comprising: inputting the description into an analyzing engine, the analyzing engine performing the steps of: extracting at least one of metadata, ID and Title from the description; tokenizing the description to generate tokenized data; normalizing the tokenized data to produce Cast information; stemming the tokenized data to generate stemmed data; pattern matching the stemmed data to produce Genre information; word sense disambiguating the stemmed data to produce Feature information; tagging the word sense disambiguated data to produce Topic information; arriving a concise descriptor of the description. This information is probabilistically matched with at least one of: product placement information; customer profile information; clustering information; and collaborative filtering information; wherein the results are forwarded to a recommendation orchestrator to generate a personalized customer specific recommendation.

### BACKGROUND

1. Field

This subject matter relates to media description. More particularly, it relates to a cohesive media description evaluation and recommendation tool.

2. Background

Media discovery tools including Electronic Program Guides (EPG) and other tools have traditionally required human-based input, being manually labeled and filed. Given the sheer amount of information and the requirement for human intervention in filing the information, these discovery tools offer very short descriptions typically labeled in very generic ways. While such information is sufficient to print a TV schedule in a newspaper, it is wholly insufficient to power systems or devices that could influence or drive media consumption for modern users.

Though some nascent people-to-people recommendation vehicles have emerged, the level of quality of these vehicles is severely compromised by the lack of asset descriptors. The lack of asset descriptors makes item-to-item recommendations impossible. In fact, the development of quality EPG and media discovery tools has been globally hindered by this lack of available data as well as the pre-dominate reliance on manual human input. Accordingly, methods and systems that address these and other deficiencies in the art for a more effective media description and recommendation system are desired.

### SUMMARY

The foregoing needs are met, to a great extent, by the present disclosure, wherein next generation media discovery tools are developed, capable of providing a discovery of content capability that generates a higher quality of recommendation.

In one of various aspects of the disclosure, a method for generating concise descriptors for a subject matter recommendation engine is provided, comprising: inputting description data of an acquired subject matter into an analyzing engine, the analyzing engine performing the steps of: extracting at least one of metadata, ID and Title from the description data; tokenizing the description to generate tokenized data; normalizing the tokenized data to produce Cast information; stemming the tokenized data to generate stemmed data; pattern matching the stemmed data to produce Genre information; word sense disambiguating the stemmed data to produce Feature information; tagging the word sense disambiguated data to produce Topic information, wherein the produced information forms a concise descriptor of the description data.

In another of various aspects of the disclosure, an apparatus for generating concise descriptors for a subject matter recommendation engine is provided, comprising: means for inputting description data of an acquired subject matter into an analyzing engine, the analyzing engine performing the steps of: means for extracting at least one of metadata, ID and Title from the description data; means for tokenizing the description to generate tokenized data; means for normalizing the tokenized data to produce Cast information; means for stemming the tokenized data to generate stemmed data; means for pattern matching the stemmed data to produce Genre information; means for word sense disambiguating the stemmed data to produce Feature information; and means for tagging the word sense disambiguated data to produce Topic information, wherein the produced information forms a concise descriptor of the description data.

In another of various aspects of the disclosure, an apparatus for generating concise descriptors from description data of subject matter, suitable for a subject matter recommendation engine is provided, comprising: a description data ingester module capable of obtaining description data; a metadata baseliner module coupled to the description data ingester module, capable of extracting at least one of metadata, ID and Title; a tokenization module coupled to the description data ingester module, capable of generating tokenized data from; a normalization module coupled to the tokenization module, capable of arriving at Cast information; a stemming module coupled to the tokenization module, capable of generating stemmed data; a pattern matching module coupled to the stemming module, capable of arriving at Genre information from the stemmed data;a word sense disambiguating module coupled to the stemming module, capable of arriving at Feature information; and a tagging module coupled to the word sense disambiguating module, capable of arriving at Topic information, wherein the produced information forms a concise descriptor of the description data.

In another of various aspects of the disclosure, a machine-readable medium is provided, comprising instructions which, when executed by a machine, cause the machine to perform operations including: receiving description data of an acquired subject matter and performing the steps of: extracting at least one of metadata, ID and Title from the description data; tokenizing the description to generate tokenized data; normalizing the tokenized data to produce Cast information; stemming the tokenized data to generate stemmed data; pattern matching the stemmed data to produce Genre information; word sense disambiguating the stemmed data to produce Feature information; and tagging the word sense disambiguated data to produce Topic information, wherein the produced information forms a concise descriptor of the description data.

In another of various aspects of the disclosure, a method for personalized recommendation of subject matter is provided, comprising: inputting a description data of the subject matter into an analyzing engine, the analyzing engine performing the steps of: extracting at least one of metadata, ID and Title from the description data; tokenizing the description to generate tokenized data; normalizing the tokenized data to produce Cast information; stemming the tokenized data to generate stemmed data; pattern matching the stemmed data to produce Genre information; word sense disambiguating the stemmed data to produce Feature information; and tagging the word sense disambiguated data to produce Topic information, wherein the produced information forms a concise descriptor of the description data; probabilistically matching indexed information from the concise descriptor with: product placement information; customer profile information; clustering information; and collaborative filtering information; and inputting at least one of the above information to a recommendation orchestrator to generate a personalized customer specific recommendation of the subject matter.

In another of various aspects of the disclosure, an apparatus for personalized recommendation of subject matter is provided, comprising: means for inputting a description data of the subject matter into an analyzing engine, the analyzing engine performing the steps of: means for extracting at least one of metadata, ID and Title from the description data; means for tokenizing the description to generate tokenized data; means for normalizing the tokenized data to produce Cast information; means for stemming the tokenized data to generate stemmed data; means for pattern matching the stemmed data to produce Genre information; means for word sense disambiguating the stemmed data to produce Feature information; and means for tagging the word sense disambiguated data to produce Topic information, wherein the produced information forms a concise descriptor of the description data; means for probabilistically matching indexed information from the concise descriptor with: product placement information; customer profile information; clustering information; and collaborative filtering information; and means for evaluating at least one of the above information, wherein a personalized customer specific recommendation of the subject matter is obtained.

In another of various aspects of the disclosure, an apparatus for personalized recommendation of subject matter is provided, comprising: a description data ingester module capable of obtaining description data; a metadata baseliner module coupled to the description data ingester module, capable of extracting at least one of metadata, ID and Title; a tokenization module coupled to the description data ingester module, capable of generating tokenized data from; a normalization module coupled to the tokenization module, capable of arriving at Cast information; a stemming module coupled to the tokenization module, capable of generating stemmed data; a pattern matching module coupled to the stemming module, capable of arriving at Genre information from the stemmed data; a word sense disambiguating module coupled to the stemming module, capable of arriving at Feature information; a tagging module coupled to the word sense disambiguating module, capable of arriving at Topic information, wherein the produced information forms a concise descriptor of the description data; a probabilistic matching module coupled to indexed information from the concise descriptor; a product placement engine coupled to the probabilistic matching module; a customer profiling module coupled to the probabilistic matching module; a clustering module coupled to the probabilistic matching module; and a collaborative filtering module coupled to the probabilistic matching module; and a recommendation orchestrator module coupled to at least one of outputs of the probabilistic matching module, product placement engine, customer profiling module, clustering module and collaborative filtering module, wherein a personalized customer specific recommendation of the subject matter is obtained.

In another of various aspects of the disclosure, a machine-readable medium is provided, comprising instructions which, when executed by a machine, cause the machine to perform operations including: receiving description data of an acquired subject matter and performing the steps of: extracting at least one of metadata, ID and Title from the description data; tokenizing the description to generate tokenized data; normalizing the tokenized data to produce Cast information; stemming the tokenized data to generate stemmed data; pattern matching the stemmed data to produce Genre information; word sense disambiguating the stemmed data to produce Feature information; and tagging the word sense disambiguated data to produce Topic information, wherein the produced information forms a concise descriptor of the description data; and probabilistically matching indexed information from the concise descriptor with at least one of: product placement information; customer profile information; clustering information; and collaborative filtering information; and inputting results of the probabilistic matching to a recommendation orchestrator to generate a personalized customer specific recommendation of the subject matter.

In another of various aspects of the disclosure, a method for personalized recommendation of subject matter having a description is provided, comprising: loading a lexical database into at least one of a taxonomy and ontology manager; creating a topics taxonomy by generating a set of topics nodes; mapping the set of topic nodes to synonym sets by generating a set of topics; performing morphological analysis on a corpus; disambiguating identified synonym sets with a traversal of hierarchy; acquiring a topics taxonomy mapped node; returning the acquired topics taxonomy mapped node as a topic; evaluating substantially all identified synonym sets; selecting most relevant topics for the corpus based on combination frequency and semantic distance; and arriving at a final topic determination for the corpus.

In another of various aspects of the disclosure, an apparatus for personalized recommendation of subject matter having a description is provided, comprising: means for loading a lexical database into at least one of a taxonomy and ontology manager; means for creating a topics taxonomy by generating a set of topics nodes; means for mapping the set of topic nodes to synonym sets by generating a set of topics; means for performing morphological analysis on a corpus; means for disambiguating identified synonym sets with a traversal of hierarchy; means for acquiring a topics taxonomy mapped node; means for returning the acquired topics taxonomy mapped node as a topic; means for evaluating substantially all identified synonym sets; means for selecting most relevant topics for the corpus based on combination frequency and semantic distance; and means for arriving at a final topic determination for the corpus.

In another of various aspects of the disclosure, a machine-readable medium is provided, comprising instructions which, when executed by a machine, cause the machine to perform operations including: loading a lexical database into at least one of a taxonomy and ontology manager; creating a topics taxonomy by generating a set of topics nodes; mapping the set of topic nodes to synonym sets by generating a set of topics; performing morphological analysis on a corpus; disambiguating identified synonym sets with a traversal of hierarchy; acquiring a topics taxonomy mapped node; returning the acquired topics taxonomy mapped node as a topic; evaluating substantially all identified synonym sets; selecting most relevant topics for the corpus based on combination frequency and semantic distance; and arriving at a final topic determination for the corpus.

### BRIEF DESCRIPTION OF THE DRAWINGS

FIG. 1 is a diagram illustrating an exemplary data analysis engine using a processing pipeline that allows accurate tagging of the data assets.

FIG. 2 is a diagram illustrating another exemplary embodiment of the data analyzer of FIG. 1 with a taxonomy resource incorporated.

FIG. 3 is a diagram illustrating an exemplary process for topics classification and paraphrasing/feature extraction.

FIG. 4 is a diagram illustrating an exemplary D-List approach.

FIG. 5 is a diagram illustrating a main server configuration for an exemplary system.

FIG. 6 is a diagram illustrating an Internet-based configuration for an exemplary system.

FIG. 7 is a diagram illustrating a system layout for an exemplary recommendation platform.

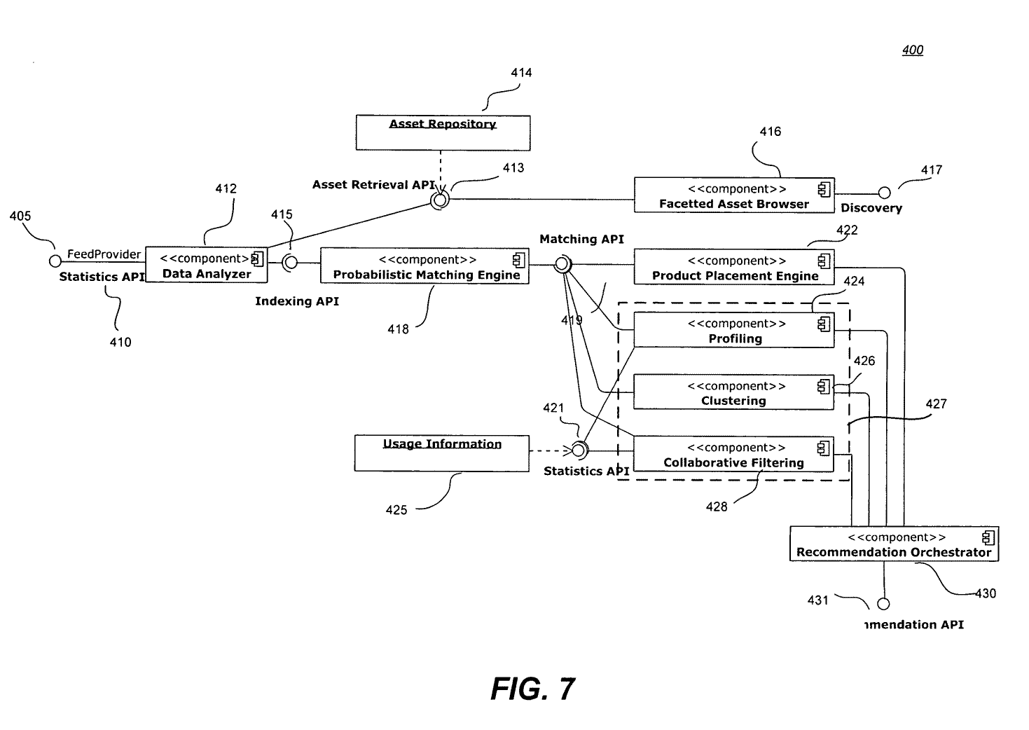

### DETAILED DESCRIPTION

Introduction

Generally speaking, most media description content and/or program descriptions are presented in a general format or pattern which is typically: title, cast, genre, topics, features. As an example, the following descriptions are presented from the Radio Times®, a TV/radio/movie guide:

Animal Cops Houston—Documentary series featuring officers fighting to combat animal cruelty across 2,500 square miles of Texas. Star, a young mare, is 200 lbs underweight, but thanks to the Houston SPCA she gets a second chance of a happy life.

The Catherine Tate Show—Comedy sketch series co-written and performed by the versatile comedy actress, featuring a gallery of memorable characters.

Courting Alex—Sitcom about a single attorney who works for her father's law firm. Alex tries to hide her relationship with Scott from her father, who doesn't approve of him.

Les Diaboliques—Classic chiller in which the wife and mistress of a despotic boarding-school headmaster conspire to do away with the tyrant. Their objective achieved, they dump his body in the school swimming pool to make the death appear accidental. But when the pool is drained there is no sign of the body—and the women are faced with increasing evidence that the victim is far from dead. A poor Hollywood remake—‘Diabolique’—appeared in 1995.

Although the above formats are specific to the Radio Times®, they are very close if not 100% identical to the format or structure observable on the Yahoo!® or Sky broadcast schedules, to name a few. Therefore, there is very little distinction in the structures of these products. Accordingly, conventional approaches to extracting higher levels of information from different sources of media descriptions cannot yield much added value, unless other attributes can be associated with the information.

Aboutness

Aboutness, or some gauge of relevance to a topic, comes with quality descriptions. If a given topic is just brushed upon, the vocabulary used to describe it will only represent a fraction of the topic language. If that fraction is too small and the author did not choose highly discriminatory words, it may be difficult to assess which of two or three topics he is referring to. If the topic is covered over several pages of text, it will be more evident for both human and computer to assess that the document is about the topic. However, this has the potential to increase the incidence of false-positive topics. Also, more information does not necessarily mean a more informed user. Typically, when a single piece of information is available, it is treated as a fact. When multiple pieces of information are available, complexity arises that most people do not like, such as decision making, appreciation of veracity, evaluation and judgment, for example. Thus, the semantic distance between the recommendations should be fairly short if the users are to identify themselves to the results, trust them, and follow them.

The nature of the semantic analysis applied on the unstructured data is a key to the ratio of recall versus precision of the platform. A processing technique that emphases the retention of the very meaning of the terms will lead to high precision and low recall. On the opposite end, a technique that places emphasis on the conceptual meaning of the terms will lead to a higher recall, but a loss of precision. While it is desirable to broaden the user horizon, “relevant recall,” not overwhelming precision, is a consideration to value. The aim of semantic analysis is to extract the aboutness of documents by analyzing the vocabulary present in the document, its statistical distribution inside the document, and by using, when possible, linguistic references to disambiguate the meaning of the words used.

Semantic Analysis

Although there is a myriad of recommendation techniques based on semantic analysis, they can, broadly speaking, be classified in two main schools:
Direct approaches using the textual descriptions of documents, and using information about the words of the text and of the corpus to compare documents to each other, etc.
Indirect approaches using an intermediary metadata layer. The first pass of processing generates metadata describing the aboutness of a given document; the second pass re-uses that aboutness information to drive information retrieval algorithms.

For the Direct approach, given the extremely short nature of program descriptions, it is unlikely that the vocabulary used will ever be rich and descriptive enough to cater for the need of direct statistical comparison. This discounts all the techniques like LSA, PLSA, K-Means, QT, etc., that solely base their analysis on the present keywords. A simple illustration of the challenges in determining aboutness is demonstrated:

ITV—19.00: John spends a week sharing the life of a Labrador breeder in rural England.

Channel 4—21.00: Jenny and her Springer-Spaniel attend a 7-days dressage class in the countryside.

The vocabulary intersection between the two entries is extremely limited and totally unhelpful: the only common words are: a, the and in—those three terms are the only clues techniques like LSA could use as the basis of the measure of relevance between those two descriptions. But to a human, intuitively, both programs are about
Dogs (topical)
Dog schooling (topical, but arguable)
Countryside (not topical)
Week long event (noise)

For Indirect approaches, several methods are considered. Conceptual clustering is interesting because supervised learning results in labeled categories, which could be used as metadata. Unfortunately, there is not enough text, not enough differentiation—or the wrong differentiation—between examples. Thus, the salient features extracted by both supervised and unsupervised learning offer very little discrimination power. Of the other Indirect methods, Prototype theory is very manual. Latent Semantic Analysis and its probabilistic variants are a pure statistical analysis of term frequencies in the available corpus. On long, coherent documents this can provide very relevant insight if the language is sufficiently dense for each topic, but on the data available on typical media descriptions, it is virtually irrelevant. The same is true for K-Neighbor clustering and all the similar fuzzy clustering approaches.

In view of these approaches, Topic vector based models seem to be more appropriate, but the question to answer is “Where are the topics coming from?” All semantic topic extraction techniques rely on segmentation and intra-document term clusters. Clearly this is again not possible given the available corpus.

As another variation, Noun-Phrase Extraction provides interesting results. Applied on the two previous examples it gives the following tokens: John, Jenny, week sharing, Labrador breeder, her Springer-Spaniel, rural England, the countryside. The tokens are interesting but it fails to address the topic mapping issue. In a way, this goes against the declared intent: the precision is maximal but the recall drops even further.

In view of the above-discussed survey of available techniques, short of manual tagging, the most accurate alternative would be to classify the data using a combination of morphological and lexical techniques to overcome the quality of the descriptions. As such, details of this approach and variations of such, as made apparent in the various exemplary embodiments, are provided herein. However, before delving into the description of the exemplary embodiments, other aspects of increasing the “relevance” or “value” of the mined information for a better user experience are introduced.

Additional Reference Data

An interesting parallel arises when comparing information queuing in a semantic analysis stack and that of a new migrant to a country. When the migrant first opens the TV guide, he is completely baffled by the description of a show. The solution for the new migrant is either to watch the program and make up his own mind, or to ask around and get a subjective explanation or description of the series rather than one of the episodes.

It is no different for the semantic analysis stack, but because it cannot watch the programs and make up its own mind, it must be provided with a knowledge base of descriptions of the series to complement the description of the episodes. In some cases a wiser decision may actually be to replace systematically the descriptions of episodes with the knowledge base entry. In variations of an exemplary embodiment, the decision to complement or replace the data asset can be taken on a series basis and the information can be stored as a flag alongside the description in the knowledge base.

Taking both knowledge base and episode information into consideration for a given show will prove useful. However, care should be exhibited as taking into account any information about the show outside of the knowledge base would lead to an increased chance of false-positives.

Personalization

The percentage of information actively pulled towards a person is relatively small. Most knowledge is pushed at the person by the highly personalized mix of influences that composes surrounding environments: family, friends, colleagues, people in general, organizations, media, etc. In spite of the reality of day-to-day experiences, most advertising projects fail to properly take into consideration the individual's needs and expectations in their marketing messages, and most findability technologies are focused on active, directed seeking, empowering users to find what they want when they want it. But findability is not limited to pull. Findability is also concerned with how information and objects finds a person. What factors influence exposure to new products, people and ideas? AdWords algorithms, one-to-one marketing, intelligent agents, email alerts, collaborative filtering, contextual advertising: what tools can be used to contextually promote content and services?

This is, of course, personalization, a strange hybrid of push and pull that is a mix of marketing and technology. The promise of personalization is simple: by modeling the behavior, needs, and preferences of an individual, we can serve up customized, targeted content and services. The benefits to the user are clear. No more searching. Information comes to you. And the value proposition for marketing is even greater. Targeted advertizing, customized messaging, and service personalization offer huge opportunities to boost sales, improve customer satisfaction and loyalty, and create communities.

Unfortunately, personalization is exceedingly difficult. Companies have poured vast amount of time and money into technologies that promise to anticipate individual interest with respect to products or knowledge, and most of these efforts have failed for a variety of reasons, which include:

The ambiguity of language: An abundance of synonyms and antonyms in all languages forces the same messy tradeoffs between precision and recall for personalization as encountered in information retrieval.

The paradox of the active user: it takes time to compile a profile that captures and specifies interest with any reasonable precision. The interest of the users will have drifted by the time the computer has come to build a representation of the interest based on the current behavior. Additionally, few users will have the patience to review these parameters.

The ambiguity of behavior: Does everyone who purchases catnip have a cat? Of course not, but it is difficult to know why an individual selects an item and for whom it is intended. Proxy selection wreaks havoc with recommendation engines.

The matter of time: It is not enough for a computer to know what you want. It must also know when you want it.

The evolution of need: The information needed, the knowledge sought, the tastes and moods of user evolve over time. Today's headline quickly becomes yesterday's news. Future use is hard to predict due to the erratic, mercurial nature of relevance decay.

The concerns of privacy: There are limits to the amount of personal data users are willing to share in return for tailored services.

These are serious problems and while there are no perfect, immediate, technical solutions, astute technology combinations can be used to minimize the impact of each of these problems. As demonstrated herein, the astute technological combinations pave the way for a modular, flexible, platform which integrates many techniques to improve the user experience well beyond the current status-quo and permanently evolving to maximize the marketing and servicing capabilities.

A corner stone for a successful information retrieval and personalization system is a deep understanding of both user behavior and of the data assets. A thorough review of the existing data assets, latent cues and consolidation approaches is, therefore, an important consideration for successful implementation.

Behavior

As can be apparent from the above discussion, recommendation is as much about analyzing and reproducing behavioral patterns, than it is about semantic similarity. Therefore, it is instructive to investigate the nature of people's viewing habits, the motivations behind their program selection, and the way they discover new programs. At the onset, one would imagine that observed data would cluster on complex topics crossovers like “doctors and nurses,” “resistance,” and “WW2.” In other words, a common preconception is that users are really discriminating in what they are watching—and that any ensuing recommendation engine would therefore be very topic-centric and extremely precise.

Unfortunately, the reality of human behavior could not be more different. The following points do not pretend to provide a full coverage of people's viewing habits, but present some important stereotypical behaviors and trends. Video on Demand (VoD), and Personal Video Recorders (PVRs), etc. are not yet mainstream, but analyzing the behavioral patterns of their early adopters can provide insight into the usage habits of a fringe population; but this sample set would not be representative of the overall population likely to use EPG services. With these caveats, the following comments emanate mostly from non-PVR users.

“Accidental watching”—This is the least useful behavior for the purpose of the study, but one that represented close to 40% of the viewings. It was typically presented as “I would not have chosen it, but my wife/husband/partner was in charge of the remote.”

“Default watching”—There is nothing on tonight and/or the user can not be bothered to decide on something and ends up watching something he knows and he does not need to pay much attention to.

“Compulsive watching”—Typically characterized by a long lasting and dedicated following of a show. The typical names which came up were “Eastenders”, “Hollyoaks”, “Big Brother.” This is a daily routine, the user gets moody when he misses it, and even if he saw all episodes for the week he is still watching the highlights or the weekend omnibus if he can. There does not seem to be any rationale for the selection of the show over similar ones.

“Hobby/Interest watching”—Also characterized by a long lasting—albeit less dedicated—following of the show. The typical names which came up were “Grand Design”, “Super Nanny”, “Top Gear”, “Panorama.” The reason to watch can be probably be summarized with two characteristics: no need to look for something else; no surprise good or bad. Those users will watch the show Panorama regardless of the theme.

“Sentimental watching”—Characterized by few and very far apart viewings, but with a consistence over the years. The typical example is “I watch romantic films with Meg Ryan”, “Why?”, “Because I always have been, I remember watching them with my mom”.

“Recommended watching”—The user has no a priori sentiment about the program, but friends, family or colleagues have said good things about it so it is worth trying out.

“Curious watching”—The user has read a review in a newspaper or seen an advertisement about the show and just watches to satisfy his curiosity. Several factors come into play, sheer curiosity can be one, but there are also social factors like not looking un-trendy at school or not wanting to feel left behind at work when chatting around the coffee machine.

“Selective watching”—The least frequent behavior, but the closest to the standard information seeking behavior. Typically applied to Documentaries and News & Current Affairs, the user will decide to watch a show as a one-off because the topic matches his or her specific interest. In certain occasions, the user may actually actively search for the program instead of waiting for it to appear on the schedule.

All those behavioral patterns are really modeled around broadcast content watched live. How do VoD and PVRs change die hard habits? It would seem that it does not much—as for most part those behavior are simply reproduced and projected in the future: instead of having to miss the Meg Ryan film playing at 2 am the user will record it and watch it at the weekend.

The behavioral pattern has not changed, but the proportion of “default” watching dramatically reduces. But that is mostly the impact of the PVR. In discussing with PVR users, it was found that within two to three days of owning the PVR they shifted from watching live to stored TV programs almost exclusively. So now, instead of having to select a single program to watch from tens of channels, PVR users have instead to select a small set of TV shows to store from the tens of thousands broadcast each week, which is even more complex.

The impact of VoD is more akin to the visit to a local BlockBusters and obey an additional set of rules: someone may invite a few friends around and watch in a row the Ocean 11 and 12 before going to the cinema to watch Ocean 13—or may be just before its premiere on TV; or replay a World Cup final from a few years ago; or watch a documentary about climate change ahead of a school expose.

Having looked at viewing patterns, how can a recommendation engine provide value to the viewer? An EPG recommendation stack will be successful if it can emulate to some degree those (relatively simple) patterns. Let's draw some parallel between the viewing patterns and the appropriate recommendations, before we develop them herein.

“Compulsive watching”—Does not stand any recommendation.

“Hobby/Interest watching”—Recommendation is primarily a reminder of the fact that the preferred show is on tomorrow night.

“Sentimental watching”—Recommendation is primarily based on a combination of genre/sub-genre and film cast.

“Recommended watching”—Recommendation is driven by collaborative filtering.

“Curious watching”—Recommendation is a marketing message pushed by the broadcaster/platform owner and toned up or down by the user profile.

“Selective watching”—Recommendation is based on the topics and features of the programs for a given genre.

It is interesting to note that the cast of a program has a really important influence over viewing habits, and some series seem to have picked up audience from the first show just because of the followers each of the actors brought with him.

Data Structure and Semantic Analysis

Words intended to represent concepts: that is the questionable foundation upon which information retrieval is built. Words in the content. Words in the query. Even collections of images, music tracks, and physical objects rely on words in the form of metadata for representation and retrieval. And words are imprecise, ambiguous, indeterminate, vague, opaque, and confusing. Our language bubbles with synonyms, homonyms, acronyms, and even contronyms (words with contradictory meanings in different contexts such as sanction, cleave, bi-weekly . . . ). And this is before one even talks about the epic numbers of spelling errors committed on a daily basis. In The Mother of Tongues Bill Bryson shares a wealth of colorful facts about language, including:
The residents of the Trobiand Islands of Papua New Guinea have a hundred words for yams, while the Maoris of New Zealand have thirty-five words for dung.
In the OED, “round” alone (that is without the variants like rounded and roundup) takes 7 pages to define or about 15,000 words of text.

Interestingly, when this ambiguity of language is subjected to statistical analysis, familiar patterns indicative of power laws emerge. First observed by the Italian economist Vilfredo Pareto in the early 1900s, power laws result in many small events coexisting with a few large events.

The most famous study of power laws in the English language was conducted by Harvard linguistic professor George Kingsley Zipf in the early 1900s. By analyzing large texts, Zipf found that a few words occur very often and many words occur very rarely. The two most frequent words can account for 10% of occurrences, the top 6 for 20% and the top 50 for 50%. Zipf postulated this occurred as a result of competition between forces for unification (general words with many meanings) and diversification (specific words with precise meaning). In the context of retrieval we might interpret these as forces of description and discrimination. The force of description dictates that the intellectual content of documents should be described as completely as possible. The force of discrimination dictates that documents should be distinguished from other documents in the system. Full text is biased towards description. Unique identifiers such as ISBN numbers, post codes etc. offer perfect discrimination but no descriptive value. Metadata (title, author, publisher) and controlled vocabularies (subject, category, format, audience) hold the middle ground.

The value of all this analysis is that while recall fails fastest, precision also drops precipitously as full-text retrieval systems grow larger. This problem is further amplified by the fact that when “computing” is used as a keyword, the underlying idea may be to retrieve “documents about computing,” and not just documents that contain the word computing. Though relevance ranking algorithms can factor in the location and the frequency of word occurrence, there is no way for 100% software program to accurately determine aboutness.

That is where metadata becomes significant. Metadata tags applied by humans can indicate aboutness thereby improving precision. This is one of Google's secret for success. Google's PageRank algorithm recognizes inbound links constructed by humans to be an excellent indicator of aboutness. Controlled vocabularies (organized lists of approved words and phrases) for populating metadata fields can further improve precision through their discriminatory power. And the specification of equivalence, hierarchical, and associative relationships can enhance recall by linking synonyms, acronyms, misspelling, and broader, narrower and related terms.

Controlled vocabularies help retrieval systems to manage the challenges of ambiguity and meaning inherent to language. And they become increasingly valuable as systems grow larger. Unfortunately, centralized manual tagging efforts also become more prohibitively expensive and time-consuming for most large-scale applications. So they often cannot be used where they are needed the most. For all these reason, information retrieval is an uphill battle. Despite the hype surrounding artificial intelligence, Bayesian pattern matching, and information visualization, computers are not even close to extracting or understanding or visually representing meaning.

Taxonomy of Words—Classification Schemes

Taxonomy, or the science of classification, and its management and mapping has traditionally been a fairly esoteric subject. Generally, there are two “schools” of taxonomy design:

The top-down approach—the structure is built by specialists who decide what is the right way to describe a domain, and they then try to squeeze the content into those categories which it is not quite meant for. The top-down approach is typically promoted by so called “librarians” or “information scientists.” They thrive more on creating extra-precise structures that may be of use to consumers. This, compounded with the fact that you need a degree in information science to be able to understand how to use the supporting tools, means that people are scared of taxonomies and have turned to folksonomies and freeform tag—the “tags cloud” often found on blog sites.

The bottom-up approach—the structure is grown in a semi-organic way, as when topics are discovered while sifting through the content. This approach is also highly human intensive, and can result in meandering or missed topic nodes.

However, a third approach can be developed—the hybrid approach. Here, an upfront analysis of the domain leading to the definition of the high level taxonomy can be generated—i.e., creating a semi-rigid supporting structure under an information science paradigm, where the less formal and less organised population or “filling” of the structure can be accomplished by subject matter experts. The “subject matter expert” can be someone considered as a TV addict or having at least a good exposure to new and trendy programs. A purpose-built tool can be created—and aimed, for example, the “TV addict” audience so the domains can be managed more dynamically and by people who have the understanding of the domain and its evolution. In other words, a knowledge based structure with human produced modifiers can be the hybrid approach.

Of course, the subject matter described herein is not limited to TV, as other forms of media or subject matter descriptions can be used. However, the most applicable field would be for TV or video services, as a first step. In this “example” context, as a preliminary baseline, the knowledge base should, but not necessarily, accommodate the following details:
Identification (ID): so episode of the series can be tracked.
Title.
Description.
Flag to indicate whether the semantic analysis should be taking the episode description into account or not.
Manually assigned tags/classification.

As mentioned earlier, the decision to incorporate a particular series in the knowledge base as well as the value for the flag is an editorial job. “Top Gear” is likely to be in with the “take episode description into account” flag on, when on the other hand “East Enders” will definitely have the flag off. “Panorama” may not need to figure in the knowledge base: each program may be so unique that the individual descriptions are sufficient and any series description may just add noise rather than substance. Building the series knowledge base is an editorial job. Third party descriptions may be used as starting point and may help but it is the quality of the editing that will drive the quality of the results.

Overview

With this understanding of the breath and difficulty of the problem and a proposed hybrid approach outlined, details for developing the proposed hybrid approach into an exemplary analysis platform and recommendation engine are fully described. In particular, a complete analysis platform for media description with a new approach to tagging and filing of media descriptions, and new methods and approaches to media discovery and media recommendations are elucidated. To power an effective user experience, the exemplary analysis platform ingests raw descriptions available from any one or more of broadcasters, VoD content providers, media sources, and so forth, and mines it, and tags it. The analysis platform provides a text parsing tool with topic lookup functionality. “Tuning” of the knowledge and related resources are facilitated by specialists that are integrated into the analysis platform and recommendation engine via a controlled software network. The end result is a semi-automatic, evolutionary analysis platform that provides a powerful semantic and lexical analysis suite, unlocking the meaning, themes or “aboutness” of media description, enabling more sanguine recommendations to a user.

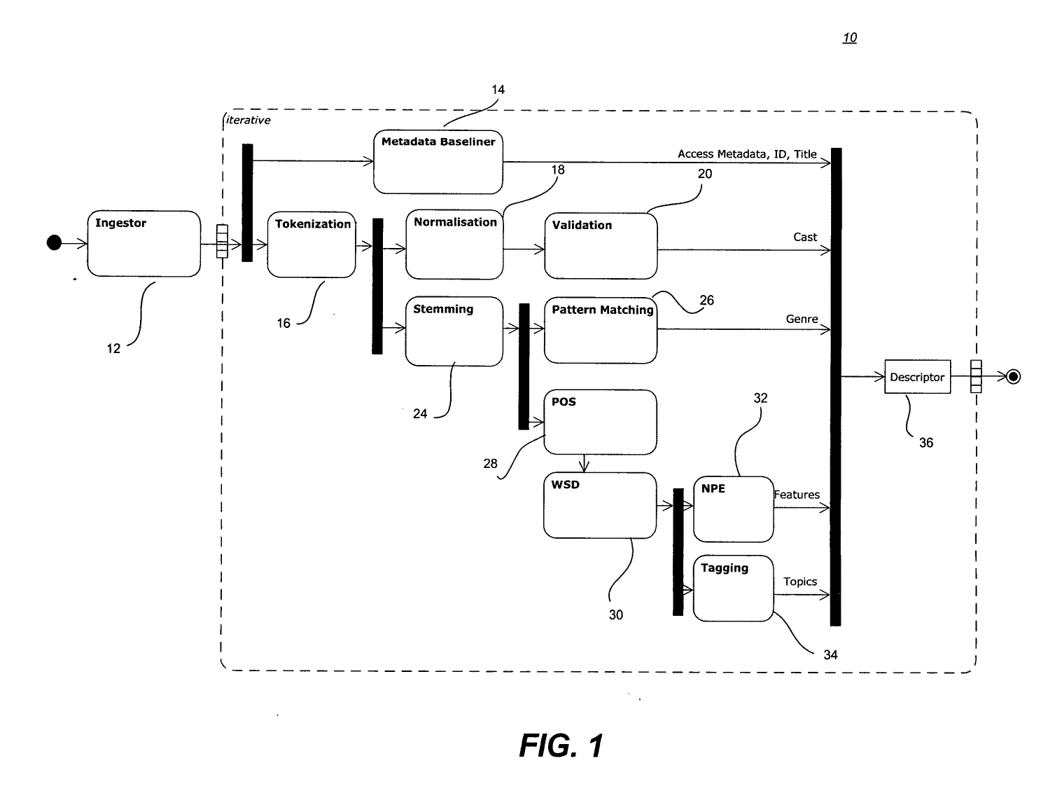

FIG. 1 illustrates an exemplary data analysis engine using an exemplary core processing pipeline 10 that allows accurate tagging of the data assets. The exemplary pipeline 10 is structured in a unique manner to provide enhanced resolution, even for sparse input. Generally speaking, the exemplary pipeline 10 creates a record of each unique piece of content, and attaches to each piece the relevant descriptions available from the sources. Thereafter, it breaks the textual descriptions into words and word compounds; normalizes the words; identifies the sense of each word; maps the word senses to the domains; and calculates the relative relevancy of each of the matched domains. An iterative approach (optional) can be utilized to mine differing layers of information from the input data to increase its effectiveness.

The elements of the exemplary pipeline 10 are a data ingestor module 12 that operates to bring in data (e.g., descriptions of the content) via any one of several methods, including, but not limited to, web crawling, subscriptions, manual input, and so forth. Output of the data ingestor module 12 is forwarded to metadata baseliner module 14 that performs a simple normalization process to convert and unify across the system the access metadata (channel, VoD store, broadcast time, etc.) and the presentation metadata (Title, etc.). Also from the data ingestor module 12, a tokenization module 16 is provided that takes a complete description and breaks it into a sequence of tokens (or words). For example, from a television listing of a show containing the description “John spends a week sharing the life of a Labrador breeder in rural England”—can be tokenized to the list {John, spends, a, week, sharing, the, life, of, a, Labrador, breeder, in, rural, England}.

Next, a normalization module 18 coupled to a validation module 20 runs on the tokenized list and identifies “known sequences” or near-matches on the permutations of the known sequences, such as actor's names, for example. This data stream provides a quick avenue to identify words that have specialized meaning. For example, the following media description shows underlined references generated by the normalization 18 and validation modules 20 that signifies the identification of the cast of a film or a documentary, etc. “The Mark of Archanon (Repeat) A case is discovered deep below the moon's surface containing a man and his son. The Alphans try to find out why they are there. With Martin Landau, Barbara Bain.”

From the tokenization module 16, a stemming module 24 takes the list of tokens and for each token/list identifies what is the semantic root of the word. The output is a stemmed list of tokens. For example, the token list {John, spend, a, week, share, the, life, of, a, Labrador, breeder, in, rural, England} generates for the first two words (assuming the English Morphological Stemmer is used) the following stemming relationship: John→John, spends→spend, . . . sharing→share (and so forth).

The quality of the stemming is important to keep the right balance between recall and precision (if one stems too much, words that are too distant from each other will be mixed up, and if one does not stem enough, very related words will not be associated). Stemming is a well developed art and therefore many variations can be utilized, depending on design preference. From the stemming module 24, a pattern matching module 26 operates to decipher patterns of words and arrangements within the description. This is relevant since most descriptions are very short. Thus, authors tend to be relatively precise in the way they position the program, episode or resource, and they also tend to follow set conventions. These conventions and arrangements can be analyzed to derive additional information, such as, for example, the genre of the program. The following example illustrates this point where the genre of motoring is detected via descriptive words placed at the front of the description.

“Motoring magazine show. Jason Plato practices some extreme piloting skills with the Blue Eagle army helicopter regiment. Vicki Butler-Henderson puts the brand new Honda Jazz through its paces. Actor Dirk Benedict, best known as Face from ‘The A-Team’, joins Jonny Smith to road test the Mercedes S-Class. And Tim Shaw finds out if it is possible for motorists to save money by servicing their cars themselves. (Last in series) (Oracle) (Followed by five news at 9)”

Also from the stemming module 24, a part-of-speech (POS) tagging module 28 is utilized. The POS tagging module 28 is responsible for annotating the token sequence with the probable role of each word. This acts as an intermediary step in the process of disambiguation. The following example illustrates one possible set of scenarios that the POS tagging module 28 would tag for different words:
a. John John+Prop+Misc
b. John John+Prop+Masc+Sg
c. John John+Prop+Fam+Sg
d. spends spend+Verb+Pres+3sg
e. a a+Let a
f a+Det+Indef+Sg
g. week week+Noun+Sg
h. sharing share+Verb+Prog
i. sharing sharing+Adj
j. sharing sharing+Noun+Sg
k. the the+Det+Def+SP
l. life life+Noun+Sg
m. of of+Prep
n. a a+Let
o. a a+Det+Indef+Sg
p. Labrador Labrador+Prop+Misc
q. Labrador Labrador+Prop+Fam+Sg
r. breeder breeder+Noun+Sg
s. in in+Noun+Sg
t. in in+Adj
u. in in+Adv
v. in in+Prep
w. rural rural+Adj
x. England England+Prop+Fam+Sg
y. England England+Prop+Place+Country

Each individual token can have many roles and senses; and using the sequence as-is to perform the tagging would lead to a less than ideal classification as this would lead to word sense clashes (as the domain mappings are performed at synset level—where the term synset or synonym set is defined as a set of one or more synonyms that are interchangeable in some context without changing the truth value of the proposition in which they are embedded). To aid in handling this difficulty, a word sense disambiguation (WSD) module 30 is used to apply a number of statistical models to the POS tagged sequence from the POS tagging module 28. And, the “most natural fit” for the transitions are identified. The following example illustrates this capability, where the first pass of the statistical model will drop roles which are less statistically probable and leave:
i. John John+Prop+Masc+Sg
ii. spends spend+Verb+Pres+3sg
iii. a+Det+Indef+Sg
iv. week week+Noun+Sg
V. sharing sharing+Adj
vi. the the+Det+Def+SP
vii. life life+Noun+Sg
viii. of of+Prep
ix. a a+Det+Indef+Sg
x. Labrador Labrador+Prop+Misc
xi. breeder breeder+Noun+Sg
xii. in in+Adv
xiii. rural rural+Adj
xiv. England England+Prop+Place+Country

The second pass will translate this list into a list of synset IDs. From the WSD module 30, a noun phrase extraction module 32 is used to mine the WSD sequence from the WSD module 30 for prominent features, which can be noun phrases or multi-word phrasal constructs of interest, for example. From our previous example, the words “Labrador breeder” and “rural England” will be identified as phrases of interest.

Next, a tagging module 34 is incorporated that also takes the WSD sequence form the WSD module 30 and maps domains (or topics) to the data. Specifically, each synset ID from the list is used to perform a look up on the domain mapping, and this results in a number of domains with associated frequency being assigned to the piece of content. The arcs between the domains in the original taxonomy are then measured to perform upfiring. For example, the above example generates the following upfired topic tags:
Dogs
Dog schooling
Pets and domestic animals
Countryside

As seen in FIG. 1, the outputs of these various modules extract different levels of information from the ingested data, and provide a detailed degree of “labeling/categorizing” the media description for subsequent evaluation directly or indirectly by a recommendation engine. Here, they can also be combined to form a “descriptor” 36 which may be a multi-data object for later evaluation by the recommendation engine.

The retrieval of those assets in the context of the recommendation engine can be a matter of building probabilistic requests—that is, using the topics and genres stored in a user profile if one tries to find relevant assets for a given user. And, using the topics and genre stored against a particular asset if one tries to find related assets. Accordingly, it is important to create accurate and easily searchable descriptors 36, and to scale them in accordance to the user experience desired. The scaling will drive the user experience (from mildly related to strongly related/focused). By weighting or adjusting thresholds, the exemplary pipeline 10 can be configured to generate different levels of descriptors 36:
fine grained descriptors 36 required by the item to item recommendation.
fine grained descriptors 36 required by the item to people recommendation.
theme weighting required in the people to people recommendation.
segmentation descriptors 36 required for audience profiling.
segmentation descriptors 36 required for product placement.

Additional specialized processing modules can also be grafted on the platform (both in the data analyzer/pipeline 10 and in the recommendation/media discovery parts—discussed later) to further enhance precision and/or recall, according to design preference. Therefore, it is expressly understood that the list of modules described in FIG. 1 may be implemented with additional modules or lesser modules, as desired, without departing from the spirit and scope of this disclosure. For example, in some instances, it may not be necessary to invoke the POS and WSC modules, 28 and 30, respectively, or the NPE and the Tagging modules, 32 and 34, respectively. Based on the breath of the input description provided, the application of these modules may not provide any additional information. Thus, in some embodiments, the exemplary processing pipeline 10 may not invoke any one or more of these modules. Additional details are provided in the following figures. Details to the various algorithms and processes used in these modules and other exemplary embodiments are provided in the attached Appendices. As should be clearly evident to one of ordinary skill in the art, the above-described process(es) take input data and provide a transformation of information of that input data to result in descriptors (and/or topics) that are more informative or provide information not even available in the original input data. Accordingly, these process(es) can be implemented in varying order in software, operating within any suitable hardware paradigm, such as is well known in the art.

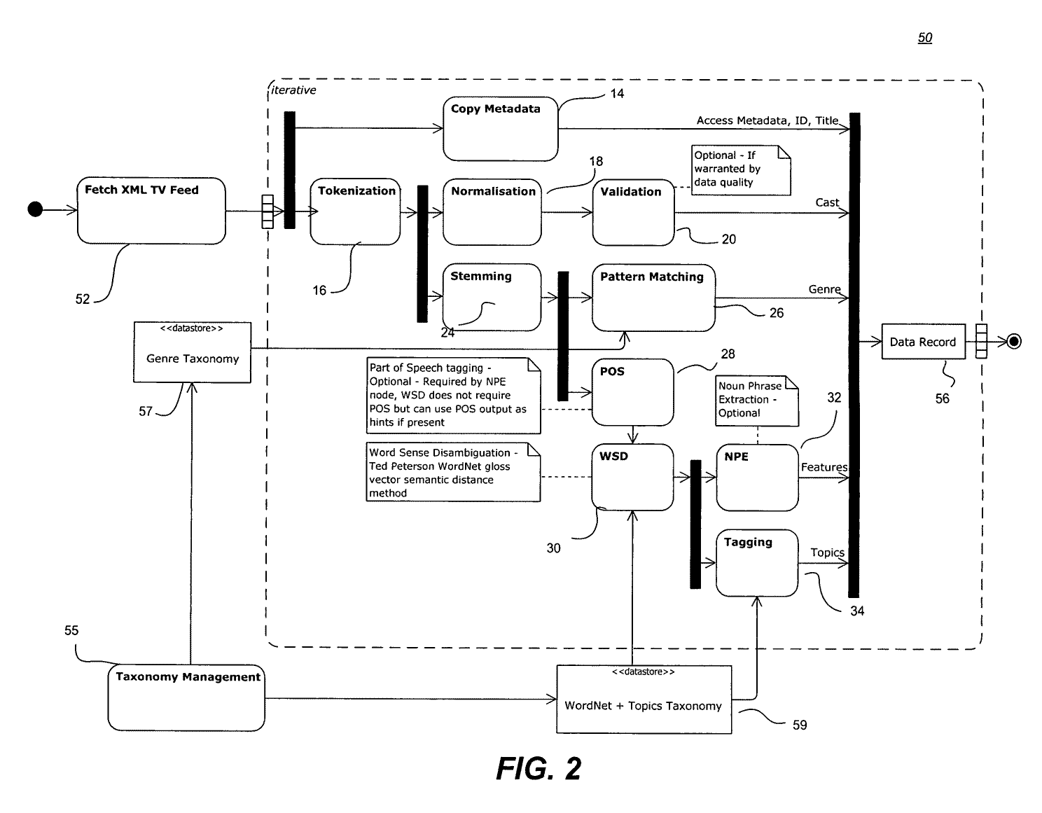

FIG. 2 illustrates another exemplary embodiment 50 of the data analyzer of FIG. 1 with a taxonomy resource incorporated. Here, the ingestor module 12 of FIG. 1 is implemented using a Fetch XML TV Feed module 52. As understood herein, other forms of input/fetching/data retrieving mechanisms may be used. Of principle difference between the embodiments of FIGS. 1 and 2 is that taxonomy management module 55 is utilized to aid in the development of the end product. The taxaonomy management module 55 controls the generation of the genre taxonomy 57 and the modification of a lexical database 59 (WordNet+topics taxonomy). Also as seen in FIG. 2, several modules may be invoked on an optional basis. The benefits of these modifications will be made evident from the discussion below.

The output of the embodiment of FIG. 2 can be converted into a data record 56 format that associates information such as the Channel, Date & Time, ID, Title, Genre and sub-genre, Cast, Topics, Features, and so forth. Most of the former items in this list can be derived from the pseudo structure. For example, the genre and sub-genre can be quite simply solved by using named entity extraction on the first sentence of each description, which often yields a very high success rate. This requires a simple taxonomy of genre 57 and (optional) sub-genre—which may be poly-hierarchical around topics like drama and comedy—populated with the noun phrases used by the editorialists. This information can be used to generate some simple classification rules to drive the pattern matching module 26. Accordingly, some of the modules shown in FIG. 2 may be invoked on an optional basis, depending on the level of accuracy and “aboutnesss” desired.

As an example, the document analysis process can also be simply location-based. That is, the closer from the beginning of the media description a known entity is located, the higher it scores, whereas the winner sets the genre. For example, given: Inferno—Action drama about a loner whose suicide attempt is interrupted by a gang of local thugs. He decides to make it his mission to stamp out the warfare between two local gangs, succeeding in making his peace with the widow of his best friend in the process. If “action drama” is a non preferred term (NPT) in the genre taxonomy 57, then its associated preferred term (PT) and the corresponding hierarchy will fire and be used for tagging. Depending on the actual taxonomy structure this could results in the above example genre being tagged as “Film”→“Drama”→“Action”. When nothing is identified by the pattern matching module 26, the incoming genre is kept.

For cast parsing, the cast and director information tend to be a simple concatenation of the names. A simple parser/tokenizer 16 can be sufficient to extract the data. It may implement a normalization module 18 as hyphenation. Although the sample data appears relatively clean, an unknown lies in the amount of misspelling contained in the source data. There is no point trying to deal with a problem before its extent is known, but if after a reference trial period a review of the data shows that misspelling are more frequent than anticipated, an omission/substitution/permutation or an N-Gram (N=3) correction approach could be utilized for correction, as well as other suitable approaches.

For feature extraction/content description, given the very short nature of the descriptions, directly using the terms from the document cannot be sufficient to identify related items. A sufficient level abstraction must be reached before this becomes possible. For example, there are no literal relationships between a poodle and a Doberman but there is a clear semantic relationship between the two.
A poodle is a kind of domestic dog.
A Doberman is a pinsher, which is a kind of guard dog which is a kind of working dog which is a kind of domestic dog.

This is a simple example because both poodle and Doberman have a single sense. Using Princeton's WordNet lexical database for the English language, the relatedness between the two concepts poodle and Doberman may vary. Various example approaches to determining “relatedness” and their varying scores can be found in Appendix B—Semantic Similarity Measures using WordNet.

In order to capture the generic features of the descriptions, the WordNet lexical database (or equivalent) is loaded in a taxonomy manager/editor 55 and nodes in the hierarchy is marked as annotating nodes. Here, the WordNet lexical database can be “adjusted” with a topics taxonomy to form a combined resource 59 to provide performance improvements over the baseline WordNet lexical database. The enhanced WordNet+topics taxonomy 59 can be used to drive the WSD module 30 and Tagging module 34 for more accurate disambiguation and topic tagging.

For example, in our previous poodle example, the attribute will be set to domestic dog. This information will be used to paraphrase the incoming description in a less precise but more topical way: domestic_dog replacing poodle in the text. If it was a simple matter of replacing words one by one, things would be very easy. Unfortunately most words have multiple meanings and disambiguation is required so the paraphrasing retains the original sense—by walking the “right” hierarchy tree. The only information the disambiguation can use is the very limited context of the sentence/description itself, and the quality of the disambiguation is bound to the precision of that context.

A typical classroom example of this fact is: The boat ran aground on the river bank. For a human, clearly the boat is not an athlete and the bank is not a financial institution. For a computer it is another matter. One powerful way to achieve word sense disambiguation is to further use the WordNet lexical information to evaluate the relatedness of the terms in a given context and assess which of the sense is most likely. Experiments have demonstrated that Ted Peterson and Siddhart Patwardhan gloss vector semantic similarity approach produces some good results on the corpus of data obtained from the Radio Times.

Using the gloss of the synsets and neighboring synsets to form the second-order co-occurrence vectors presents a unique way to create the much needed context, given the brevity of the extracts, and provide the only source of vocabulary that can be used to “hop” between concepts until a cluster is identified—source normally provided by the surrounding sentences/paragraphs. For extremely short excerpts, using the vector pairs similarity measure produces better results but at a great computation expense. The details of these approaches are provided in the attached Appendices. These features can be used to adjunct the WordNet with the topics taxonomy 59.

It should be noted, to increase the success rate of the WSD module 30, POS tagging 34 can be performed to feed the WSD module 30 with a POS tag hint for each term. A suitable approach would be to use POS tagging with optional morphological analysis and Hidden Markov Model (HMM) model; and the WSD module 30 could use a version of Ted Petersen and Siddhart Patwardhan's Context Vector approach, as one of several possible approaches.

Additional precision can be obtained by extracting noun phrases 32 from the description. Having paraphrased the text, a fairly precise idea of the sense of each term or term compound in isolation is obtained. Domain (i.e., topic) mappings for the marked lexical nodes is the next step. Such mappings are available through public domain projects like Suggested Upper Merged Ontology (SUMO) or WordNet Domains. As such, SUMO (incorporated by reference herein in its entirety) provides a mapping of the WordNet synsets to around 20,000 “higher-order” terms. Unfortunately those terms tend to be in an organizational hierarchy rather than a topic hierarchy—for example, nurse dos not relate to medicine but to position and female. However, with the taxonomy management 55, these deficiencies can be overcome where the marked nodes for the paraphrasing could be derived as “one level away” from the mappings.

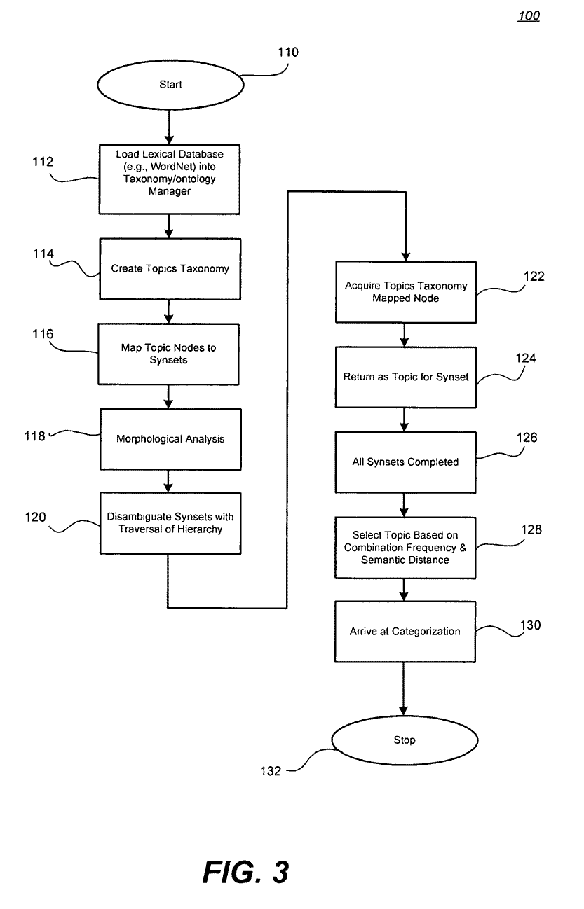

FIG. 3 illustrates an exemplary process 100 for topics classification and paraphrasing/feature extraction, in accordance with the techniques described herein. The exemplary process 100 proceeds from a start state 110 to loading a lexical database (for example WordNet) in a taxonomy/ontology manager 112. Next, a topics taxonomy is created 114 by generating a nominal number of topic nodes. After the topic nodes have been created, the exemplary process 100 maps the topic nodes onto the synsets 116. This operates to generate a baseline set of topics relating to the loaded lexical database. At runtime on a given corpus, morphological analysis 118 can be performed. Next, the disambiguated synset in the hierarchy is identified and traversing the hierarchy 120 is performed, while keeping a trail of the encountered nodes. When a topics taxonomy mapped node 122 is reached, it is returned it as the topic 124, with the last item added to the trail as the paraphrasing term. When the lookups have been performed for all the synsets 126, the most relevant topics is selected 128 using the combination frequency and semantic distance. From this, the most relevant topic is returned 130 as the categorization for the program. The exemplary process then terminates at 132. The above approach is understood to be optimal for very short text excerpts and builds on a pre-existing taxonomy, enabling rapid domain maturity and increased accuracy for media related descriptions.

As should be apparent, the above approach(es) can be interpreted as statistical algorithms relying on the existence of a well populated lexical database. WordNet has been identified as a suitable lexical database, but other lexical databases are available as well for other languages. EuroWordNet is providing a mapping of many European languages on the original WordNet synsets. This means that not only can the algorithms remain mostly identical (tuning will be required), but the approach capitalizes on the effort that went in to create the topics mapping on top of WordNet. Therefore, it is possible to recommend programs across multiple languages.

Indexing Pipeline

Various aspects of the exemplary embodiments require the use of a fast searching and storing capability. For example, results of the semantic analysis of the raw data are stored in a data store (or record) so the recommendation platform can use them. Although a relational database could be used as a first port of call, indices, or more precisely, a set of synchronized indices, can provide much better support to the type of matching techniques that are provided by the platform.

In essence, the Indexing Pipeline is a simple application of the semantic analysis layer. Its takes each program or series description in turn and applies semantic analysis techniques on it. The result of this process is a set of terms describing each record, each record being subsequently added to the set of indices.

The set of indices, forming the core index structure, can be composed of four indices:
A termlist index listing all the terms for a given record, parameterized by the within document frequency (wdf).
A postlist inverted index listing all the records given a term, parameterized by the wdf.
A lexicon index listing all the terms in use with their corresponding document frequency (df).
An attribute index listing the attribute name and value pairs for each document.

Such index structure can later be extended to support straightforward search functionality by adding the following indices:
A position index listing all the ordinal positions keyed by term and record, in order to allow phrase and proximity searching.
A record index to associate content with each record.
A byteposition index listing all the byte offsets keyed by term and record, in order to allow the dynamic summarization and highlighting of the data contained in the record index.

It should be noted that such index structures are typically forms of B-Trees or multi-root B-Tree derivatives, which are inherently dynamically updatable. It can be argued that C-Trees have an edge over B-Trees in terms of performance, but their lack of updatability (short of taking blocks offline) is a core limitation as it means that incremental data indexing isn't (easily) possible. Notwithstanding this limitation, in some embodiments, the use of a C-Tree may be used.

A number of open-source and commercial implementations of such B-Tree structures are available: Xapian, Lucene, Quartz, etc. . . . basically any advanced probabilistic search engine that has published comprehensive APIs, but also specialized data stores like BerckleyDB/SleepyCat. Each of these may be utilized in the exemplary system, depending on design preference.

Data Partitioning

If all the data was stored in a single index, it would create a non-negligible management overhead associated with the archiving of old records, for example, identification at run time of which program should not be part of a recommendation set because it occurs in the past, not to mention more “technical” issues associated with the B-Tree implementations like increasing fragmentation, number of levels between the root and the data blocks, etc. The simple way around those issues is to partition the data and, instead of using an index at runtime, use a dynamic index list (i.e., D-List).

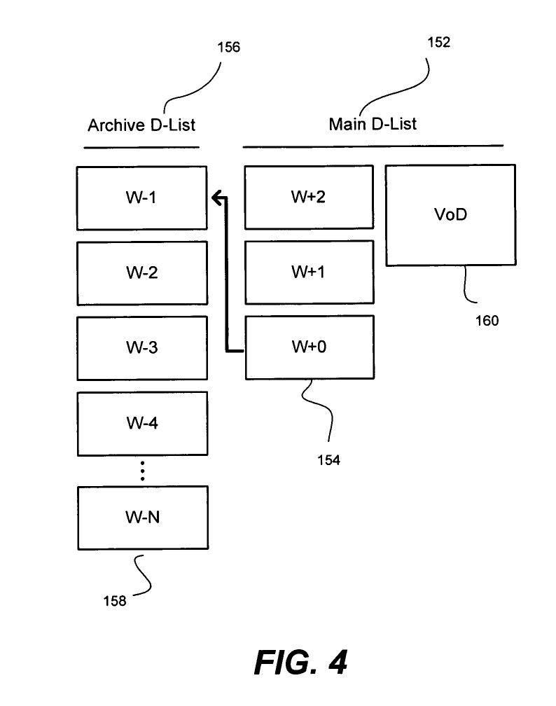

FIG. 4 illustrates an exemplary D-List approach. Here, a Main D-List 152 contains a series of indices 154 for weekly programs and (optional) VoD programs 160. Also, an Archive D-List 156 containing a stack of older programs or past programs 158 is shown. Of course, other programs and/or stacks may be utilized according to design preference, therefore, increasing or decreasing the types of program stacks may be made without departing from the spirit of this disclosure. This exemplary arrangement allows using different sets of indices, depending on the query.

In operation, the partitioning strategy would be based on a rotation of weekly indices. When a new week of programs are available, they are indexed in an index of their own (in series of indices 154); this index is added when needed to the D-List 152. At the end of a given week the first index in the main D-List 152 is demoted to the Archive D-List 156 and the first index of the Archive D-List 156 is deleted. A single, separate, index 160 can exist for the VoD content as this changes less often and tends not to be deleted.

The depth of the stack of indices on the Archive D-List 156 is entirely dependent on the data retention policy. This “searchable” index of parsed and tagged information provides a convenient breakdown of the input media information data, upon which a probabilistic model can be applied for information retrieval to begin matching the media information for recommendation objectives. There are a number of probabilistic matching engines available in the art, any one or more of which may be used, according to design preference.

Operational Management

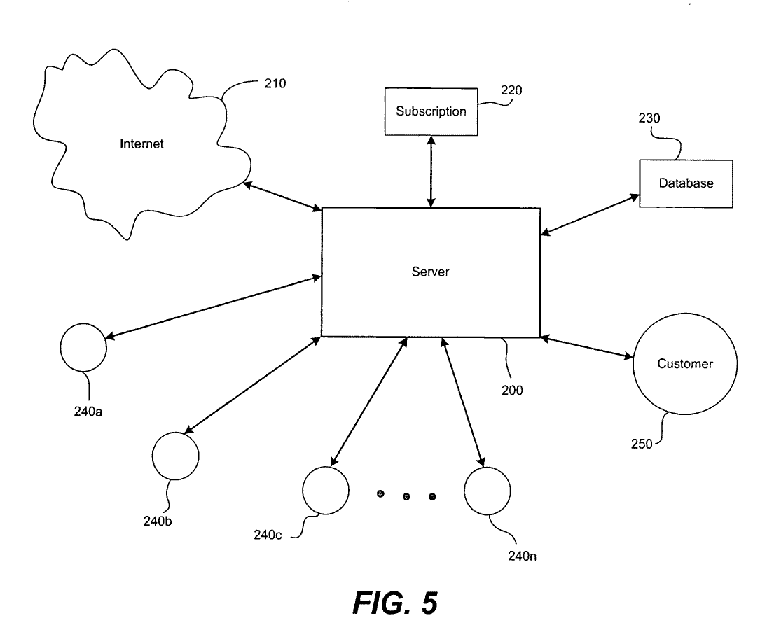

The exemplary embodiments of the systems and methods described above and below can be implemented in a server/network environment. For example, FIG. 5 is a diagram illustrating the deployment of an exemplary system utilizing the concepts described herein, in a main server configuration. The main server 200 hosts the exemplary data analysis and recommendation platforms with a management system (not shown) and has access to “information” networks such as the Internet 210, subscriptions 220, and a local/remote database(s) 230. The Internet 210 provides a conduit for the main server 200 to acquire media description information via a web crawler or other Internet-capable searching mechanism. In addition to the Internet 210, the main server 200 may utilize subscription-based information 220 from Lexis-Nexis or other forms of payment services (e.g., Comcast, TV Guide, etc.). Local/remote database 230 may contain information that is archived or does not fit within the information paradigms of the Internet 210 and the subscriptions 220. The main server 200 “digests” information from the above resources and provides tailoring capabilities to editorialists 240a-n, that are controlled by the main server 200 (presumably running version control software or some equivalent thereof). Customer(s) 250 can be connected to the main server 200 to obtain or receive the recommendations generated therein.

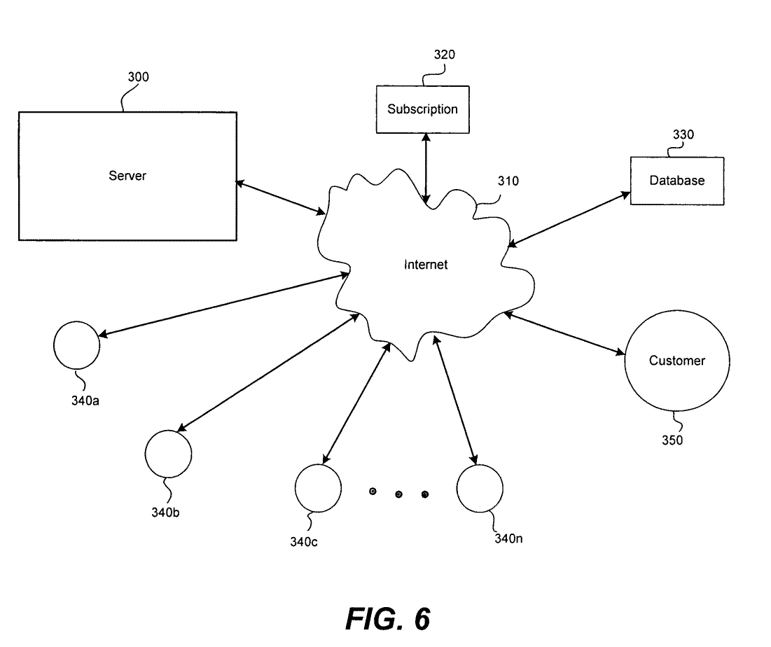

FIG. 6 is an illustration of an exemplary implementation using an Internet-centric environment. Here, the primary conduit of information is via the Internet 310, where the server 300, subscription provider 320, database 330, editorialists 340a-n, and customer(s) 350 are all linked into each other via the Internet 310. FIG.6 is understood to be self-explanatory and therefore is not further elaborated.

As is apparent in network environments, it may be possible to have some of the exemplary techniques described herein to be hosted by more than one main server or (in a net-friendly environment) hosted by several server-capable machines on the Internet 210, 310. Also, as is understood in the world of networking, multiple networks of any known configuration (cloud, pico-cells, hub-spoke, peer-to-peer, and so forth) may be used to implement the exemplary systems and methods described. Therefore, modifications and changes may be made to the arrangement and configuration of the various elements shown in FIGS. 5-6, without departing from the spirit and scope of this disclosure.

A software driven platform can be developed to allow several people to collaborate on the development and management of the topics taxonomy and its mappings onto a database. For example, a WordNet lexical database is discussed above as the baseline database. However, it is known that WordNet Domains, though having an extensive taxonomy, have a large bias towards news and current affairs. Therefore, the software driven platform will allow the editorialists (users) to extend WordNet for localized expression or vertical specific vernacular, expressions and compound terms. The taxonomy, the mappings and the WordNet extensions can be maintained in a version controlled environment (for example, Subversion—SVN) to ensure currency and consistency across all the users.

The software driven platform also allows logging of statistics to accumulate data about the structure of the program description so, over time, that information can be used to refine the automated tagging process (e.g., using POS tagging using statistics from the manually tagged Brown corpus is of a limited interest, however, using transition frequencies as identified over a few thousands real program description should provide vastly more accurate results).

Recommendation Engine Implementation

Using a software driven user-interface to drive editing of mappings generated by the exemplary data analyzer (e.g., embodiments of FIGS. 1-2), a recommendation engine platform is now described. FIG. 11 displays a system layout for implementation of a recommendation platform 400. The overall platform 400 contains the data analyzer 412 (described above) with a feed provider 410 (for example, a conduit of information—Internet, subscriptions, and so forth) that channels information generated or obtained by the statistics applications programming interface (API) 405—which may be running on servers on the Internet, desktops, and so forth, for use by the data analyzer 412. The data analyzer 412 is also provided with asset information from the asset repository 414, which may be a compilation of earlier asset information (e.g., D-list), which is forwarded by the asset retrieval API 413. The asset retrieval API 413 may also be in communication with a facetted asset browser 416 which has access to other assets that are not in the asset repository 414. The facetted asset browser 416 can be populated or controlled with information provided by discovery API 417.

Information garnered from the results of the data analyzer 412 is indexed by the indexing API 415 and a probabilistic matching engine 418 is utilized on the indexed information. Results of the probabilistic matching from the “input” media descriptions is compared/matched via the matching API 419 to the customer's information using a product placement engine 422, profiling engine 424, clustering algorithm(s) 426, collaborative filtering algorithm(s) 428, and (optional) usage information 425. In some embodiments, the profiling engine 424, clustering algorithm(s) 426, and collaborative filtering algorithm(s) 428, may be proxied by a personalization engine 427. That is, in some embodiments, it may be deemed necessary to only have one or more of the capabilities provided by the profiling engine 424, clustering algorithm(s) 426, and the collaborative filtering algorithm(s) 428, rather than all their capabilities, and as such, the personalization engine 427 may invoke only those modules/engines as needed. Also, the personalization engine 427 may include additional capabilities not provided by these modules. Coordination of the comparison/matching is managed by the recommendation orchestrator 430. The usage information 425 aspect is optionally input to the various algorithms/engines via a statistic API 421. The recommendation orchestrator 430 utilizes a recommendation API 431 to generate the desired results. The recommendation orchestrator 430 may also orchestrate between the various inputs, applying differing levels of thresholds and operations, as desired, to generate the desired results.

Considerations in the use of these various elements, as well as their details, are described below in the context of providing an effective mechanism for product placement. However, it is understood that the exemplary embodiments herein can be implemented in a different context, as according to design purpose.

Product Placement

Services—like Amazon.com—tend to all rely on keywords. Given the data processing that has taken place, there are two sources of keywords for each program: the topics and the features. The decision to use one or the other will be based on the specific requirements of the product placement service. If features are used, it is highly likely that more information will be available that the target system can accept, in which case only the Top Terms for the document will be returned (the set of terms with a ratio wdf over cf that is well above the average). As product placement can be implemented in a myriad of manners, other aspects of the exemplary embodiments are disclosed.

Probabilistic Matching

One advantage of using a B-Tree derived storage over a database is the ability to use a complex probabilistic query structure rather than suffer from the limited capabilities of SQL. Query can have complex tree-like structure and use probabilistic operators such as ANDMAYBE. Examples of suitable probabilistic tools are Xapian and Quartz, which have C++, Java and Python APIs allowing complex composite probabilistic and Boolean filter queries to be executed. Of course, other tools may be used without departing from the spirit and scope of this disclosure. Features of such tools should be able to request the most relevant documents matching queries.

Profiling

Profiling is used to recommend programs given a particular user profile. The starting point is the corpus and a user profile. If internally the recommendation algorithms are using terms or keywords, these are not suitable for user consumption, as the user cannot be expected to add and manage keywords in his profile. Therefore, the challenge is to extract and manage the metadata from a collection of programs that have been marked or recorded by the user while allowing the user to review, edit or rank that list in an intuitive fashion. Given the nature of the application, the only thing that can be presented to the user and be intuitive is a list of programs. The profile of a user will therefore be a set or array of program lists. The array is indexed by domain space (i.e. genre and/or sub-genre) and the list contains the IDs of the programs the user marked or recorded for that particular domain space.

When the user wishes to review his profile, he can be presented with the list of programs broken down by domain space and he can remove from the list those programs he feels are less representative of his interest. Because the user interests are changing overtime, their profile should not be an accumulation of all the programs they have marked since they started using the system but instead be a representative sample of the last few months. Similarly the last few marked program should have more weight than older one.

Because of the partitioning of the profile by domain space, it can be difficult to assess the relative relevance of two recommended programs that belong to two different domain spaces. A simple way around that would be to perform a relative ranking of the domain spaces by the number of programs marked for each, but it would certainly be more relevant to ask the user to prioritize his domains of interest as part of the profile review process. Either method may be used, depending on design preference.

It is very likely that the span of the profile window will overtime be user-type and genre specific. Heavy users of the system are likely to watching a lot of TV and follow the latest trends: they need a more dynamic profile only taking a few weeks into consideration. On the other hand lighter users are likely to watch less TV, but carefully chose programs around a couple of well identified domain spaces (e.g.: documentaries or film).

Taking benefit of the efforts that went in building the index representation of the data, the actual act of profiling becomes a simple task. For each genre in turn, the core metadata, the topics and Top Terms for the set of older program IDs contained in the user profile can be retrieved. All the information for the newer program IDs is contained in the user profile and also can be retrieved. Upon this, a probabilistic query is run using the terms. The probabilistic query can return any corresponding programs that are not already featured in the user profile.

Evaluating the Top Terms for a set of records can be resource intensive. In general, there is an almost linear complexity—“almost” because the time consuming part is O(n) and the faster part is O(log(n))—but the stress is almost entirely input/output (IO) bound. In this context it makes sense to de-correlate the retrieval of the Top Terms from the profiling request and isolate the function on a separate application node so the IO overhead does not affect the response time of the runtime queries.

In such an implementation, program marking, recording or profile review—in essence anything that touches the profile representation—triggers a Top Terms recalculation event for the corresponding user. The Top Terms results are stored in the profile for consumption at runtime by the profiling module 424. At busy times this approach may result in profile alterations not being immediately reflected in the recommendations, but this is an acceptable trade off in order to safeguard the quality of service of the application. Note that such a node specialization should not be necessary until the load reaches a threshold, for example, a hundred of queries per second mark.

Clustering

Program clustering is used to recommend a set of programs given a selected program. Two main types of program clustering can be envisioned:
Real-time, on-the-fly matching of programs;
Pre-processed program relation maps.

Most clustering techniques fall under the pre-processing genre: vector and matrix based clustering techniques such LSA, PLSA, etc. They involve a one-off study of the complete corpus typically involving loading a vectorized description of every item of the corpus into memory, building a matrix of invert term frequencies and diagonalizing the matrix against an arbitrary number of dimensions. The result is a large relationship map between data items that can be readily walked to find the most probable similar items. There are two fundamental limitations with such approaches:
They do not support the addition of new items to the corpus without a complete recalculation.
Because the relationship mappings are pre-defined and the vectors hidden at the point of analysis and use of the results, corrective weighting of the vector items according to a particular user profile is difficult to retrofit in the algorithm.

Overcoming those two limitations is one reason the probabilistic approach to clustering is used. The probabilistic approach to clustering relies on the probabilistic model of information retrieval implemented in the underlying search engine. The information about the selected program is retrieved from the index by ID and either all its metadata, or its Top Terms are retrieved and used to build a probabilistic query. Because the query is resolved at runtime, the personal user profile can be used to add emphasis to certain topics of the currently selected program. Note that because the Top Terms are only calculated on a single program, this can be done at runtime without much overheads and performance impact on other operations. Note that, as for profiling, initially the features will not be included in the queries. Their impact on the user experience and confidence must first be understood and the simpler probabilistic model validated before it is extended. As a result, initially, clustering will lead to recommendations based on (in order of relevance in the results):
Genre+Actor+Topic
Genre+Actor
Genre+Topic

Collaborative Filtering

The basic idea of collaborative filtering is to provide a user with program recommendations based on the opinion or like-minded users. Such systems, especially the k-nearest neighbor based ones, have achieved widespread success on the web. Traditionally, collaborative filtering algorithms have been studying the user space and analyzing user-user relationships to make recommendations. While those memory-based techniques are producing great results for a small number of users, they do not scale well for hundreds of thousands of users. They also require thousands of users with enough ratings before they can be expected to provide interesting recommendations; this is often referred to as the sparsity issue.

Given the anticipated audience, model-based collaborative filtering techniques are explored. Model-based collaborative filtering works by first developing a model of user ratings. Algorithms in this category take a probabilistic approach and envision the collaborative filtering process as computing the expected value of a user prediction, given his rating/marking on other items. In comparison to memory-based schemes, model-based algorithms are typically faster at query time though they might have expensive learning or updating phases.

A number of model-based techniques have been documented, based on linear algebra: SVD, PCA, Eigenvectors, SlopeOne. or other techniques borrowed from Artificial Intelligence such as Bayesian inferencing or Latent Classes. The requirements for the collaborative filtering stack can be summarized as follows:
Easy to implement and maintain.
Updatable on the fly; the marking of new programs by a user should change the recommendation he is offered.
Efficient at query time: queries should be fast, possibly at the expense of storage.
Expect little from first visitors: a user with few programs marked should receive valid recommendations.
Accurate within reason: the scheme should be competitive, but a minor gain in accuracy is not always worth a major sacrifice in simplicity or scalability.

The Recommendation Orchestrator

The recommendation orchestrator 430 can be an algorithm and will be responsible for calling each module as per the rules set out in the configuration and, as needed, to:
Calculate the relative importance of narrow-field and left-field recommendations.
Blend the results according to the user profile and the calling page/context.
Emphasis or de-emphasis the time induced relevance decay.
Collapse or expand similar or identical results.
Group and cluster results by salient facets.
Band results by date to present the combined results.
De-duplicate the results as in some occasion a result from the collaborative filtering may be identical to one returned by the profiling algorithm.

Miscellaneous Considerations

The quality of recommendations generated by a collaborative filtering stack is dependent on the training of that system by the opinions expressed by the community of users. The more precise those recommendations are, the better the algorithm will perform. This is often implemented by “thumbs up” and “thumbs down” rating buttons.

The approach to track the users' opinions is typically to present the user with the voting buttons once they have consulted the document/viewed the material. This has worked well in a closed environment where the delivery of the content is managed by the application. In the present case, the actual watching of the program can take place weeks after the marking of the program—and by someone else. In this context, getting the user vote is tricky: presenting the voting button at the time the program is marked may be considered irrelevant as the user has not had the chance to see the program. Therefore, expecting the user to come back after watching the program and provide a rating is unrealistic at best.

The implementation of the overall recommendation platform 400 described above will follow the modular philosophy of the design and will ensure that each module can be configurable on a per taxonomy node basis, i.e., for each genre/sub-genre.

Consequently, the recommendation platform 400 can be considered as a generic toolkit capable of providing recommendations in all contexts. But not every approach makes sense in every context, and it is worth restating that there is no point in forcing the system to generate related and recommended programs if one can not naturally think of one.

For example, currently there is no show that can be conceivably related to Eastenders, as well as to other soaps like Coronation Street. Users of such long running soaps are territorial, so they would either be watching it already, or more likely, hate it. Profiling or clustering of these types of shows may not provide any benefit. So, for shows like Eastenders or Coronation Street, only collaborative filtering and keyword generation for product placement and advertising may be needed, with the option for potential links to buy missed episodes from a VoD library, etc. Also, configuration and tuning of the recommendation platform could be directed to the definition of films and documentaries, things that lend themselves to all the different kinds of recommendations, having either trailers to download and pay for, VoD content to consume, and so forth.

It should be understood that the specific order or hierarchy of steps in the processes and methods disclosed herein are example(s) of exemplary approaches. Therefore, based on design preferences, the order and/or hierarchy may be changed without departing from the spirit and scope of this disclosure. Further, those of ordinary skill in the art understand that the exemplary processes, logical blocks, and methods disclosed herein can be implemented as software operating in a hardware system, such as a computer or state-machine. The software may be resident in memory in any form, such as, for example, RAM, ROM, flash, CD-ROM, and so forth. The software may operate as a single system, or be distributed over several platforms. The software may be resident on servers and/or client machines.

It will be understood that many additional changes in the details, materials, steps and arrangement including the order thereof, which have been herein described and illustrated to explain the nature of the invention, may be made by those skilled in the art within the principle and scope of the invention as expressed in the appended claims.

### Appendices

### Appendix A—Glossary

cf—Collection Frequency or Corpus Frequency—the number of times a term appears in the corpus, sometimes reduced to the number of documents in which the term appears (less precise)

wdf—Within Document Frequency—the number of times a term appears in a given document

Top Terms—The set of terms deemed to best describe a document or set of documents, as their ratio wdf over cf is much higher than the average.

D-List—Dynamic index List, runtime mechanism used to allow a query to span multiple indices

NPT—Non Preferred Term: a synonym, a term equivalent to a Preferred Term and related to it via an EQ-UF relationship (EQuivalent—Use For)

PT—Preferred Term: an agreed label, a taxonomy node name, a member term of a controlled vocabulary

### Appendix B—Semantic Similarity Measures Using WordNet

Path Length

A simple node-counting scheme. The relatedness score is inversely proportional to the number of nodes along the shortest path between the synsets. The shortest possible path occurs when the two synsets are the same, in which case the length is 1. Thus, the maximum relatedness value is 1.

Leacock & Chodorow

The relatedness measure proposed by Leacock and Chodorow is—log (length/(2*D)), where length is the length of the shortest path between the two synsets (using node-counting) and D is the maximum depth of the taxonomy.

The fact that the lch measure takes into account the depth of the taxonomy in which the synsets are found means that the behavior of the measure is profoundly affected by the presence or absence of a unique root node. If there is a unique root node, then there are only two taxonomies: one for nouns and one for verbs. All nouns, then, will be in the same taxonomy and all verbs will be in the same taxonomy. D for the noun taxonomy will be somewhere around 18, depending upon the version of WordNet, and for verbs, it will be 14. If the root node is not being used, however, then there are nine different noun taxonomies and over 560 different verb taxonomies, each with a different value for D.

If the root node is not being used, then it is possible for synsets to belong to more than one taxonomy. For example, the synset containing turtledove#n#2 belongs to two taxonomies: one rooted at group#n#1 and one rooted at entity#n#1. In such a case, the relatedness is computed by finding the LCS that results in the shortest path between the synsets. The value of D, then, is the maximum depth of the taxonomy in which the LCS is found. If the LCS belongs to more than one taxonomy, then the taxonomy with the greatest maximum depth is selected (i.e., the largest value for D).

Wu & Palmer

The Wu & Palmer measure calculates relatedness by considering the depths of the two synsets in the WordNet taxonomies, along with the depth of the LCS. The formula is score=2*depth(lcs)/(depth(s1)+depth(s2)). This means that 0<score<=1. The score can never be zero because the depth of the LCS is never zero (the depth of the root of a taxonomy is one). The score is one if the two input synsets are the same.

Resnik

The related value is equal to the information content (IC) of the Least Common Subsumer (LCS) (most informative subsumer). This means that the value will always be greater-than or equal-to zero. The upper bound on the value is generally quite large and varies depending upon the size of the corpus used to determine information content values. To be precise, the upper bound should be In (N) where N is the number of words in the corpus.

Hirst & St-Onge

This measure works by finding lexical chains linking the two word senses. There are three classes of relations that are considered: extra-strong, strong, and medium-strong. The maximum relatedness score is 16.

Jiang & Conrath

The relatedness value returned by the jcn measure is equal to 1/jcn_distance, where jcn_distance is equal to IC(synset1)+IC(synset2)−2*IC(lcs).

There are two special cases that need to be handled carefully when computing relatedness; both of these involve the case when jcn_distance is zero.

In the first case, we have ic(synset1)=ic(synset2)=ic(lcs)=0. In an ideal world, this would only happen when all three concepts, viz. synset1, synset2, and lcs, are the root node. However, when a synset has a frequency count of zero, we use the value 0 for the information content. In this first case, we return 0 due to lack of data.

In the second case, we have ic(synset1)+ic(synset2)=2*ic(ics). This is almost always found when synset1=synset2=lcs (i.e., the two input synsets are the same). Intuitively this is the case of maximum relatedness, which would be infinity, but it is impossible to return infinity. Insteady we find the smallest possible distance greater than zero and return the multiplicative inverse of that distance.

Extended Gloss Overlaps

The Extended Gloss Overlaps measure works by finding overlaps in the glosses of the two synsets. The relatedness score is the sum of the squares of the overlap lengths. For example, a single word overlap results in a score of 1. Two single word overlaps results in a score of 2. A two word overlap (i.e., two consecutive words) results in a score of 4. A three word overlap results in a score of 9.

Lin

The relatedness value returned by the lin measure is a number equal to 2*IC(lcs)/(IC(synset1)+IC(synset2)). Where IC(x) is the information content of x. One can observe, then, that the relatedness value will be greater-than or equal-to zero and less-than or equal-to one.

If the information content of any of either synset1 or synset2 is zero, then zero is returned as the relatedness score, due to lack of data. Ideally, the information content of a synset would be zero only if that synset were the root node, but when the frequency of a synset is zero, we use the value of zero as the information content because of a lack of better alternatives.

Gloss Vector

The Gloss Vector measure works by forming second-order co-occurrence vectors from the glosses of WordNet definitions of concepts. The relatedness of two concepts is determined as the cosine of the angle between their gloss vectors. In order to get around the data sparsity issues presented by extremely short glosses, this measure augments the glosses of concepts with glosses of adjacent concepts as defined by WordNet relations.

Gloss Vector (Pairwise)

The Gloss Vector (pairwise) measure is very similar to the “regular” Gloss Vector measure, except in the way it augments the glosses of concepts with adjacent glosses. The regular Gloss Vector measure first combines the adjacent glosses to form one large “super-gloss” and creates a single vector corresponding to each of the two concepts from the two “super-glosses”. The pairwise Gloss Vector measure, on the other hand, forms separate vectors corresponding to each of the adjacent glosses (does not form a single super gloss). For example separate vectors will be created for the hyponyms, the holonyms, the meronyms, etc. of the two concepts. The measure then takes the sum of the individual cosines of the corresponding gloss vectors, i.e. the cosine of the angle between the hyponym vectors is added to the cosine of the angle between the holonym vectors, and so on. From empirical studies, we have found that the regular Gloss Vector measure performs better than the pairwise Gloss Vector measure.

### Appendix C—Sample Lexical Database Synsets

The core of the “knowledge” about language is a lexical database modeled on the Princeton WordNet. The database defines cluster of words of identical or near-identical meaning which can be used interchangeably.

For example all of the following nouns

banker's_bill n 1 2 @˜1 0 13221270

banknote n 1 2 @˜1 0 13221270

bill n 10 6 @˜#p % p+; 10 7 06450193 06430339 13221270 00546006 06400907 07151099 01739745 06702368 02811652 02811422

federal_reserve_note n 1 2 @˜1 0 13221270

government_note n 1 2 @˜1 0 13221270

greenback n 1 2 @˜1 0 13221270

note n 9 4 @#m+9 9 06538053 06418196 04672309 13221270 06773228 06672526 14243695 06985524 13225928

bank_bill n 1 2 @˜1 0 13221270

belong to the same synset or group of synonyms

13221270 21 n 09 bill 0 note 1 government_note 0 bank_bill 0 banker's_bill 0 bank_note 0 banknote 0 Federal_Reserve_note 0 greenback 1 009 @13214821 n 0000˜13221687 n 0000˜13222546 n 0000˜13222659 n 0000˜13222768 n 0000˜13222879 n 0000˜13222987 n 0000˜13223271 n 0000˜13223369 n 0000| a piece of paper money (especially one issued by a central bank); “he peeled off five one-thousand-zloty notes”

### Appendix D—Incorporated References

The following publications provide background information and specific details to some algorithms and aspects of the modules used in various exemplary embodiments described herein, the contents of which are understood to be expressly incorporated by reference in their entirety:

Patwardhan, Banerjee, and Pedersen. 2007. UMND1: Unsupervised Word Sense Disambiguation Using Contextual Semantic Relatedness. Proceedings of SemEval-2007: 4th International Workshop on Semantic Evaluations, Jun. 23-24, 2007, Prague, Czech Republic.

Patwardhan and Pedersen. 2006. Using WordNet Based Context Vectors to Estimate the Semantic Relatedness of Concepts. Proceedings of the EACL 2006 Workshop Making Sense of Sense—Bringing Computational Linguistics and Psycholinguistics Together, Apr. 4, 2006, Trento, Italy.

Michelizzi. 2005. Semantic Relatedness Applied to All Words Sense Disambiguation. Master of Science Thesis, Department of Computer Science, University of Minnesota, Duluth, July, 2005.

M. Stevenson and M. Greenwood. 2005. A semantic approach to ie pattern induction. Proceedings of the 43rd Annual Meeting of the Association for Computational Linguistics, pages 379-386, Ann Arbor, Mich., June 2005.

Luisa Bentivogli, Pamela Fomer, Bernardo Magnini and Emanuele Pianta. 2004. Revising WordNet Domains Hierarchy: Semantics, Coverage, and Balancing. Proceedings of COLING 2004 Workshop on “Multilingual Linguistic Resources”, Geneva, Switzerland, Aug. 28, 2004, pp. 101-108.

P. Clough and M. Stevenson. 2004. Cross-language Information Retrieval using EuroWordNet and Word Sense Disambiguation. European Conference on Information Retreieval (ECIR '04), pp 327-337.

S. Banerjee and T. Pedersen. 2003. Extended gloss overlaps as a measure of semantic relatedness. Proceedings of the Eighteenth International Conference on Artificial Intelligence (IJCAI-03), Acapulco, Mexico, August, 2003.

D. Inkpen and G. Hirst. 2003. Automatic sense disambiguation of the near-synonyms in a dictionary entry. Proceedings of the 4th Conference on Intelligent Text Processing and Computational Linguistics (CICLing-2003), pages 258-267, Mexico City, February.

S. Patwardhan, S. Banerjee, and T. Pedersen. 2003. Using measures of semantic relatedness for word sense disambiguation. Proceedings of the Fourth International Conference on Intelligent Text Processing and Computational Linguistics (CICLING-03), Mexico City, Mexico, February.

Budanitsky and G. Hirst. 2001. Semantic distance in WordNet: An experimental, application-oriented evaluation of five measures. Workshop on Word-Net and Other Lexical Resources, Second meeting of the North American Chapter of the Association for Computational Linguistics, Pittsburgh, June 200.

S. McDonald and M. Ramscar. 2001. Testing the distributional hypothesis: The influence of context on judgments of semantic similarity. Proceedings of the 23rd Annual Conference of the Cognitive Science Society, Edinburgh, Scotland.

Bernardo Magnini and Gabriela Cavaglia. 2000. Integrating Subject Field Codes into WordNet. Proceedings of LREC-2000, Second International Conference on Language Resources and Evaluation, Athens, Greece, 31 May-2 Jun., 2000, pp. 1413-1418.

H. Jing, E. Tzoukermann. 1999. Information Retrieval Based on Context Distance and Morphology.” Proceedings of the 22nd Annual International Conference on Research and Development in Information Retrieval (SIGIR '99), pp. 90-96.

P. Resnik. 1999. Semantic Similarity in a Taxonomy: An Information-Based Measure and its Application to Problems of Ambiguity in Natural Language. Journal of Artificial Intelligence Research (JAIR), 11, pp. 95-130.

H. Schutze. 1998. Automatic word sense discrimination. Computational Linguistics, 24(1):97-123.

C. Leacock and M. Chodorow. 1998. Combining local context and WordNet similarity for word sense identification. In C. Fellbaum, editor, WordNet: An electronic lexical database, pages 265-283. MIT Press.

D. Lin. 1998. An information-theoretic definition of similarity. Proceedings of International Conference on Machine Learning, Madison, Wis., August.

J. Jiang and D. Conrath. 1997. Semantic similarity based on corpus statistics and lexical taxonomy. Proceedings on International Conference on Research in Computational Linguistics, Taiwan.

T. K. Landauer and S. T. Dumais. 1997. A solution to plato's problem: The latent semantic analysis theory of acquisition, induction and representation of knowledge. Psychological Review, 104:211-240.

P. Resnik. 1995. Using information content to evaluate semantic similarity in a taxonomy. Proceedings of the 14th International Joint Conference on Artificial Intelligence, Montreal, August.

Y. Niwa and Y. Nitta. 1994. Co-occurrence vectors from corpora versus distance vectors from dictionaries. Proceedings of the Fifteenth International Conference on Computational Linguistics, pages 304-309, Kyoto, Japan.

R. Krovetz and W. B. Croft. 1992. Lexical Ambiguity and Information Retrieval. ACM Transactions on Information Systems, 10(2), 115-141.

G. A. Miller and W. G. Charles. 1991. Contextual correlates of semantic similarity. Language and Cognitive Processes, 6(1):1-28.

Y. Wilks, D. Fass, C. Guo, J. McDonald, T. Plate, and B. Slator. 1990. Providing machine tractable dictionary tools. Machine Translation, 5:99-154.

Z. Harris. 1985. Distributional structure. The Philosophy of Linguistics, pages 26-47. Oxford University Press, New York.

D. Camine, E. J. Kameenui, and G. Coyle. 1984. Utilization of contextual information in determining the meaning of unfamiliar words. Reading Research Quarterly, 19:188-204.

P. Procter, editor. 1978. Longman Dictionary of Contemporary English. Longman Group Ltd., Essex, UK.

H. Rubenstein and J. B. Goodenough. 1965. Contextual correlates of synonymy. Communications of the ACM, 8:627-633, October.

Independent Research Project in Applied Mathematics. 2007. Slope One predictor on consumer data. Helsinky University, System Analysis Lab, February

Petros Drineas, lordanis Kerenidis, and Prabhakar Raghavan. 2002. Competitive recommendation systems. Proc. of the 34th annual ACM symposium on Theory of computing, pages 82-90. A CM Press

K. Goldberg, T. Roeder, D. Gupta, and C. Perkins. 2001. Eigentaste: A constant time collaborative filtering algorithm. Information Retrieval, 4(2):133-151, 2001.

B. M. Sarwar, G. Karypis, J. A. Konstan, and J. Riedl. 2001. Item-based collaborative filtering recommender algorithms. WWW10

B. M. Sarwar, G. Karypis, J. A. Konstan, and J. T. Riedl. 2000. Application of dimensionality reduction in recommender system—a case study. WEBKDD '00, pages 82-90.

S. H. S. Chee. 2000. Rectree: A linear collaborative filtering algorithm. Master's thesis, Simon Fraser University, November.

T. Hofmann and J. Puzicha. 1999. Latent class models for collaborative filtering. International Joint Conference in Artificial Intelligence.

J. Herlocker, J. Konstan, A. Borchers, and J. Riedl. 1999. An algorithmic framework for performing collaborative filtering. Proc. of Research and Development in Information Retrieval.

D. Billsus and M. Pazzani. 1998. Learning collaborative information filterings. AAAI Workshop on Recommender Systems,

J. S. Breese, D. Heckerman, and C. Kadie. 1998. Empirical analysis of predictive algorithms for collaborative filtering. 14^{th} Conference on Uncertainty in AI. Morgan Kaufmann, July

What is claimed is:

1. A method for generating concise descriptors for a subject matter recommendation engine, comprising:
inputting description data of an acquired subject matter into an analyzing engine, the analyzing engine performing the steps of:
extracting at least one of metadata, ID and Title from the description data;
tokenizing the description to generate tokenized data;
normalizing the tokenized data to produce Cast information;
stemming the tokenized data to generate stemmed data;
pattern matching the stemmed data to produce Genre information;
word sense disambiguating the stemmed data to produce Feature information; and
tagging the word sense disambiguated data to produce Topic information, wherein the produced information forms a concise descriptor of the description data.

2. The method of claim 1, further comprising, validating the normalized data to produce the Cast information;

3. The method of claim 1, further comprising, part-of-speech tagging the stemmed data prior to word sense disambiguating.

4. The method of claim 1, further comprising, noun phrase extracting after the word sense disambiguating to produce the Feature information.

5. The method of claim 1, further comprising, obtaining a plurality of description data for inputting into the analyzing engine.

6. The method of claim 1, wherein the acquired subject matter is acquired using at least one of a Fetch XML and TV feed mining operation.

7. The method of claim 1, wherein the descriptor is stored into a B-tree.

8. The method of claim 1, further comprising providing a taxonomy management system, the taxonomy management system comprising:
a genre taxonomy resource for the pattern matching; and
a lexical database and topics taxonomy resource for the tagging.

9. The method of claim 8, wherein the lexical database is a WordNet database.

10. The method of claim 1, wherein the word sense disambiguating utilizes a semantic distance method.

11. An apparatus for generating concise descriptors for a subject matter recommendation engine, comprising:
means for inputting description data of an acquired subject matter into an analyzing engine, the analyzing engine comprising:
means for extracting at least one of metadata, ID and Title from the description data;
means for tokenizing the description to generate tokenized data;
means for normalizing the tokenized data to produce Cast information;
means for stemming the tokenized data to generate stemmed data;
means for pattern matching the stemmed data to produce Genre information;
means for word sense disambiguating the stemmed data to produce Feature information; and
means for tagging the word sense disambiguated data to produce Topic information, wherein the produced information forms a concise descriptor of the description data.

12. An apparatus for generating concise descriptors from description data of subject matter, suitable for a subject matter recommendation engine, comprising:
a description data ingester module capable of obtaining description data;
a metadata baseliner module coupled to the description data ingester module, capable of extracting at least one of metadata, ID and Title;
a tokenization module coupled to the description data ingester module, capable of generating tokenized data from;
a normalization module coupled to the tokenization module, capable of arriving at Cast information;
a stemming module coupled to the tokenization module, capable of generating stemmed data;
a pattern matching module coupled to the stemming module, capable of arriving at Genre information from the stemmed data;
a word sense disambiguating module coupled to the stemming module, capable of arriving at Feature information; and
a tagging module coupled to the word sense disambiguating module, capable of arriving at Topic information,
wherein the produced information forms a concise descriptor of the description data.

13. The apparatus of claim 12, further comprising, a validation module coupled to the normalization module to produce the Cast information.

14. The apparatus of claim 12, further comprising, a part-of-speech tagging module coupled to the stemming module prior to the word sense disambiguating module.

15. The apparatus of claim 12, further comprising, a noun phrase extracting module coupled to the word sense disambiguating module to produce Feature information.

16. The apparatus of claim 12, wherein the description data ingester module obtains data description data from at least one of a Fetch XML and TV Feed operation.

17. The apparatus of claim 12, further comprising a taxonomy management system containing a genre taxonomy resource coupled to the pattern matching module and a lexical database and topics taxonomy module coupled to the word sense disambiguation module.

18. The apparatus of claim 17, wherein the lexical database is a WordNet database.

19. The apparatus of claim 12, wherein the word sense disambiguation module utilizes a semantic distance method.

20. A machine-readable medium comprising instructions which, when executed by a machine, cause the machine to perform operations including:
receiving description data of an acquired subject matter and performing the steps of:
extracting at least one of metadata, ID and Title from the description data;
tokenizing the description to generate tokenized data;
normalizing the tokenized data to produce Cast information;
stemming the tokenized data to generate stemmed data;
pattern matching the stemmed data to produce Genre information;
word sense disambiguating the stemmed data to produce Feature information; and
tagging the word sense disambiguated data to produce Topic information, wherein the produced information forms a concise descriptor of the description data.

21. A method for personalized recommendation of subject matter, comprising:
inputting a description data of the subject matter into an analyzing engine, the analyzing engine performing the steps of:
extracting at least one of metadata, ID and Title from the description data;
tokenizing the description to generate tokenized data;
normalizing the tokenized data to produce Cast information;
stemming the tokenized data to generate stemmed data;
pattern matching the stemmed data to produce Genre information;
word sense disambiguating the stemmed data to produce Feature information; and
tagging the word sense disambiguated data to produce Topic information, wherein the produced information forms a concise descriptor of the description data;
probabilistically matching indexed information from the concise descriptor with:
product placement information;
customer profile information;
clustering information; and
collaborative filtering information; and
inputting at least one of above information to a recommendation orchestrator to generate a personalized customer specific recommendation of the subject matter.

22. The method of claim 21, further comprising applying statistical usage information to the customer profile information and the collaborative filtering information.

23. The method of claim 21, wherein the description data is retrieved from an asset repository.

24. An apparatus for personalized recommendation of subject matter, comprising:
means for inputting a description data of the subject matter into an analyzing engine, the analyzing engine performing the steps of:
means for extracting at least one of metadata, ID and Title from the description data;
means for tokenizing the description to generate tokenized data;
means for normalizing the tokenized data to produce Cast information;
means for stemming the tokenized data to generate stemmed data;
means for pattern matching the stemmed data to produce Genre information;
means for word sense disambiguating the stemmed data to produce Feature information; and
means for tagging the word sense disambiguated data to produce Topic information, wherein the produced information forms a concise descriptor of the description data;
means for probabilistically matching indexed information from the concise descriptor with:
product placement information;
customer profile information;
clustering information; and
collaborative filtering information; and
means for evaluating at least one of the above information, wherein a personalized customer specific recommendation of the subject matter is obtained.

25. An apparatus for personalized recommendation of subject matter, comprising:
a description data ingester module capable of obtaining description data;
a metadata baseliner module coupled to the description data ingester module, capable of extracting at least one of metadata, ID and Title;
a tokenization module coupled to the description data ingester module, capable of generating tokenized data from;
a normalization module coupled to the tokenization module, capable of arriving at Cast information;
a stemming module coupled to the tokenization module, capable of generating stemmed data;
a pattern matching module coupled to the stemming module, capable of arriving at Genre information from the stemmed data;
a word sense disambiguating module coupled to the stemming module, capable of arriving at Feature information;
a tagging module coupled to the word sense disambiguating module, capable of arriving at Topic information, wherein the produced information forms a concise descriptor of the description data;
a probabilistic matching module coupled to indexed information from the concise descriptor;
a product placement engine coupled to the probabilistic matching module;
a customer profiling module coupled to the probabilistic matching module;
a clustering module coupled to the probabilistic matching module; and
a collaborative filtering module coupled to the probabilistic matching module; and
a recommendation orchestrator module coupled to at least one of outputs of the probabilistic matching module, product placement engine, customer profiling module, clustering module and collaborative filtering module, wherein a personalized customer specific recommendation of the subject matter is obtained.

26. The apparatus of claim 25, further comprising a statistical usage module coupled to the customer profiling module and the collaborative filtering module.

27. The apparatus of claim 25, further comprising an asset repository containing previous concise descriptors, wherein indexed information of the previous concise descriptors is provided to the probabilistic matching module.

28. A machine-readable medium comprising instructions which, when executed by a machine, cause the machine to perform operations including:
receiving description data of an acquired subject matter and performing the steps of:
extracting at least one of metadata, ID and Title from the description data;
tokenizing the description to generate tokenized data;
normalizing the tokenized data to produce Cast information;
stemming the tokenized data to generate stemmed data;
pattern matching the stemmed data to produce Genre information;
word sense disambiguating the stemmed data to produce Feature information; and
tagging the word sense disambiguated data to produce Topic information wherein the produced information forms a concise descriptor of the description data;
probabilistically matching indexed information from the concise descriptor with at least one of:
product placement information;
customer profile information;
clustering information; and
collaborative filtering information; and
inputting results of the above information to a recommendation orchestrator to generate a personalized customer specific recommendation of the subject matter.

29. A method for personalized recommendation of subject matter having a description, comprising:
loading a lexical database into at least one of a taxonomy and ontology manager;
creating a topics taxonomy by generating a set of topics nodes;
mapping the set of topic nodes to synonym sets by generating a set of topics;
performing morphological analysis on a corpus;
disambiguating identified synonym sets with a traversal of hierarchy;
acquiring a topics taxonomy mapped node;
returning the acquired topics taxonomy mapped node as a topic;
evaluating substantially all identified synonym sets;
selecting most relevant topics for the corpus based on combination frequency and semantic distance; and
arriving at a final topic determination for the corpus.

30. An apparatus for personalized recommendation of subject matter having a description, comprising:
means for loading a lexical database into at least one of a taxonomy and ontology manager;
means for creating a topics taxonomy by generating a set of topics nodes;
means for mapping the set of topic nodes to synonym sets by generating a set of topics;
means for performing morphological analysis on a corpus;
means for disambiguating identified synonym sets with a traversal of hierarchy;
means for acquiring a topics taxonomy mapped node;
means for returning the acquired topics taxonomy mapped node as a topic;
means for evaluating substantially all identified synonym sets;
means for selecting most relevant topics for the corpus based on combination frequency and semantic distance; and
means for arriving at a final topic determination for the corpus.

31. A machine-readable medium comprising instructions which, when executed by a machine, cause the machine to perform operations including:
loading a lexical database into at least one of a taxonomy and ontology manager;
creating a topics taxonomy by generating a set of topics nodes;
mapping the set of topic nodes to synonym sets by generating a set of topics;
performing morphological analysis on a corpus;
disambiguating identified synonym sets with a traversal of hierarchy;
acquiring a topics taxonomy mapped node;
returning the acquired topics taxonomy mapped node as a topic;
evaluating substantially all identified synonym sets;
selecting most relevant topics for the corpus based on combination frequency and semantic distance; and
arriving at a final topic determination for the corpus.
